(19) United States
(12) Patent Application Publication
(10) Pub. No.: US 2012/0140167 A1
(43) Pub. Date: Jun. 7, 2012

(54) Dynamic Changeable Focus Contact And Intraocular Lens

(75) Inventor: Ronald D. Blum, Roanoke, VA (US)

(73) Assignee: PixelOptics, Inc., Roanoke, VA (US)

(21) Appl. No.: 13/286,802

(22) Filed: Nov. 1, 2011

Related U.S. Application Data
(60) Provisional application No. 61/408,764, filed on Nov. 1, 2010.
(60) Provisional application No. 61/410,466, filed on Nov. 5, 2010.

(51) Int. Cl. G02C 7/04

(52) U.S. Cl. 351/159.34; 351/159.73

(57) ABSTRACT

In some embodiments, a first device may be provided. The first device may include a first lens that comprises a contact lens or an intraocular lens. The first lens may include an electronic component and a dynamic optic, where the dynamic optic is configured to provide a first optical add power and a second optical add power, where the first and the second optical add powers are different. The dynamic optic may comprise a fluid lens.

### CROSS-REFERENCES TO RELATED APPLICATIONS

This application claims benefit under 35 U.S.C. §119(e) of U.S. provisional patent application No. 61/408,764, filed on Nov. 1, 2010; and U.S. provisional patent application No. 61/410,466, filed on Nov. 5, 2010. The entire disclosure of each of these applications is incorporated herein by reference for all purposes and in their entireties.

### BACKGROUND OF THE INVENTION

In general, both intraocular lenses and contact lenses may provide a sufficient means of vision correction for myopes, hyperopes and astigmats (i.e. individuals afflicted with any of the corresponding vision impairments) and are widely used for vision correction by younger people. This appears to be especially true in developed countries, where individuals may have better access to intraocular lenses and contact lenses (which may be more expensive, or more difficult to obtain in less developed countries). Typically, intraocular lenses and contact lenses may not be comfortably used by presbyopes (i.e. individuals suffering from presbyopia), because, for instance, presbyopes typically require an added plus optical power (to correct for accommodation deficiency) only when viewing near objects, and may require a second optical power for intermediate or far distance viewing. Currently, the only commercially available intraocular and contact lenses that attempt to provide correction of presbyopia do so by utilizing a split optic—i.e. one optic for far vision and one optic for near vision—which tends to create a double image on the retina at all object distances. This may be distracting to a wearer and/or may impair the wearer's vision.

### BRIEF SUMMARY OF THE INVENTION

Embodiments may provide a device that comprises a contact lens or intraocular lens that includes a dynamic optic (e.g. an optical component that may provide at least two different optical powers), such as a dynamic fluid lens, and one or more electronic components. Embodiments may also provide a device that may include a self-contained electronics module that may comprise a dynamic optic (or a portion thereof), as well as methods of manufacturing such devices. The self-contained electronics module may comprise additional electronic components, and may be disposed within an intraocular or contact lens. Embodiments may thereby comprise a dynamic intraocular or contact lens that provides a wearer with a plurality of optical powers, depending for instance on whether the wearer is viewing (or intends to view) objects at near, intermediate, or far distance.

In some embodiments, a first method may be provided. The first method may include the steps of providing a dynamic optic and disposing the dynamic optic into a first lens, where the first lens is anyone of a contact lens or an intraocular lens. The dynamic optic may comprise a fluid lens. The first method may further include the step of providing an electronic component and disposing the electronic component into the first lens.

In some embodiments, in the first method as described above, the electronic component may be configured to drive the dynamic optic between a first optical power and a second optical power. In some embodiments, the electronic component may drive the dynamic optic by applying a force on a flexible element of the dynamic optic. In some embodiments, the electronic component may drive the dynamic optic by applying a force to a liquid such that the fluid exerts a force on a flexible element of the dynamic optic.

In some embodiments, in the first method as described above, the electronic component may include an electromagnet. In some embodiments, in the first method as described above, the electronic component may comprise an electronic controlled bladder. In some embodiments, in the first method as described above, the first lens may include one or more micro nanowires.

In some embodiments, in the first method as described above that includes the steps of providing an electronic component and a dynamic optic that may comprise a fluid lens and disposing the electronic component and the dynamic optic into anyone of a contact lens or an intraocular lens, the first method may further include the steps of disposing the dynamic optic into an electronics module and sealing the electronics module so as to form a self-contained electronics module. In some embodiments, the step of disposing the dynamic optic into the first lens in the first method as described above may comprise disposing the self-contained electronics module into the intraocular lens or the contact lens.

In some embodiments, in the first method as described above, the self-contained electronics module may further contain the electronic component. In some embodiments, in the first method as described above, the self-contained electronics module may include or contain any one of, or some combination of: an electromagnet; an electronic controlled bladder; one or more micro nanowires; a kinetic energy source; and/or a capacitor.

In some embodiments, in the first method as described above that includes the steps of disposing a dynamic optic into an electronics module and sealing the electronics module, the step of disposing the self-contained electronics module into the first lens may comprise disposing the self-contained electronics module into a contact lens matrix. In some embodiments, the contact lens matrix may comprise a soft lens, a hard lens, or a combination thereof.

In some embodiments, in the first method as described above that includes the steps of disposing a dynamic optic into an electronics module and sealing the electronics module, the step of sealing the electronics module may include any one of: heat sealing, laser welding, ultrasonic welding, or the use of an adhesive bond.

In some embodiments, in the first method as described above that includes the steps of disposing a dynamic optic into an electronics module and sealing the electronics module, the self-contained electronics module may contain a power supply; a controller; and/or a sensing mechanism, and the dynamic optic may be configured to provide a first optical power and a second optical power. In some embodiments, the self-contained electronics module may comprise at least one of a plastic or a glass. In some embodiments, the self-contained electronics module may include one or more glass sheets. In some embodiments, the one or more glass sheets may have a thickness that is between approximately 10 and 200 microns. Preferably, the one or more glass sheets may have a thickness that is between approximately 25 and 50 microns. In some embodiments, the one or more glass sheets may have a refractive index that is between approximately 1.45 and 1.75. Preferably, the one or more glass sheets may have a refractive index that is between approximately 1.50 and 1.70. In some embodiments, one or more glass sheets may comprise Borofloat glass.

In some embodiments, in the first method as described above that includes the steps of disposing a dynamic optic into an electronics module and sealing the electronics module, the self-contained electronics module may comprise one or more plastic sheets. In some embodiments, the one or more plastic sheets may have a thickness that is between approximately 5 and 200 microns. Preferably, the one or more plastic sheets may have a thickness that is between approximately 7 and 25 microns. In some embodiments, the one or more plastic sheets may comprise polyfluorocarbons. In some embodiments, the one or more plastic sheets may comprise PVDF or Tedlar.

In some embodiments, a first method may be provided that may include the step of providing an electronics module that contains an electronic component and a dynamic optic. The electronics module may have a thickness that is less than approximately 125 microns. The first method may further include the step of sealing the electronics module so as to form a self-contained electronics module.

In some embodiments, in the first method as described above, the electronics module may have a thickness that is less than 90 microns. In some embodiments, the electronics module may have a thickness that is less than 60 microns. In some embodiments, the electronic component may comprise any one of, or some combination of an electromagnet or an electronically controlled bladder. In some embodiments, the first method may further include the step of disposing the dynamic optic into anyone of: a contact lens or an intraocular lens.

In some embodiments, in the first method as described above that includes that steps of providing an electronics module having a thickness that is less than approximately 125 microns that comprises an electronic component and a dynamic optic, the dynamic optic may be discretely switchable between a first optical power and a second optical power. In some embodiments, the dynamic optic may be continuously tunable between a first optical power and a second optical power. In some embodiments, the dynamic optic may comprise a fluid lens.

In some embodiments, a first device may be provided. The first device may include a first lens that comprises a contact lens or an intraocular lens. The first lens may include an electronic component and a dynamic optic, where the dynamic optic is configured to provide a first optical add power and a second optical add power, where the first and the second optical add powers are different. The dynamic optic may comprise a fluid lens.

In some embodiments, in the first device as described above that includes a first lens having an electronic component and a dynamic optic that may comprise a fluid lens, the electronic component may be configured to drive the dynamic optic between the first optical power and the second optical power. In some embodiments, the electronic component may drive the dynamic optic by applying a force on a flexible element of the dynamic optic. In some embodiments, the electronic component drives the dynamic optic by applying a force to a fluid such that the fluid exerts a force on a flexible element of the dynamic optic.

In some embodiments, in the first device as described above that includes a first lens comprising a contact lens or an intraocular lens, an electronic component, and a dynamic optic that may include a fluid lens, the electronic component may comprise an electromagnet. In some embodiments, the electronic component may comprise an electronic controlled bladder. In some embodiments, the first lens may include any one of, or some combination of: micro nanotubes, a kinetic energy source, or a capacitor.

In some embodiments, in the first device as described above that includes a first lens comprising a contact lens or an intraocular lens, an electronic component, and a dynamic optic that may include a fluid lens, the first device may further comprise a self-contained electronics module. The self-contained electronics module may contain the dynamic optic (or a portion thereof). In some embodiments, the self-contained electronics module may further contain the electronic component.

In some embodiments, in the first device as described above that includes a first lens and a self-contained electronics module that comprises a dynamic optic configured to provide at least a first optical power and a second optical power, the self-contained electronics module may further include any one of, or some combination of: a power supply; a controller; and a sensing mechanism.

In some embodiments, in the first device as described above that includes a first lens and a self-contained electronics module that contains an electronic component and a dynamic optic configured to provide at least a first optical power and a second optical power, the first device may further include a contact lens matrix. In some embodiments, the self-contained electronics module may be disposed within the contact lens matrix.

In some embodiments, in the first device as described above that includes a first lens and a self-contained electronics module that contains an electronic component and a dynamic optic configured to provide at least a first optical power and a second optical power, the self-contained electronics module may further include an electromagnet. In some embodiments, the electromagnet, or a portion thereof, may be coupled to at least a portion of the dynamic lens.

In some embodiments, in the first device as described above that includes a first lens and a self-contained electronics module that contains an electronic component and a dynamic optic that comprises a fluid lens configured to provide at least a first optical power and a second optical power, and an electromagnet coupled to at least a portion of the dynamic lens, a first portion of the electromagnet may be disposed outside of the self-contained electronics module and a second portion of the electromagnet may be disposed within the self-contained electronics module. In some embodiments, when current or voltage is supplied to at least one of the first portion or the second portion of the electromagnet, the first portion and the second portion may interact with one another. In some embodiments, the first portion and the second portion may comprise separate electromagnets.

In some embodiments, in the first device as described above that includes a first lens and a self-contained electronics module that contains an electronic component and a dynamic optic that may comprise a fluid lens configured to provide at least a first optical power and a second optical power, and where the first lens includes an electromagnet, the first lens may also comprise a magnetic material. The electromagnet and/or the magnetic material may be disposed within the self-contained electronics module, while the other component may be disposed outside the self-contained electronics module. In some embodiments, when current or voltage is supplied to the electromagnet, the electromagnet and the magnetic material may interact with one another.

In some embodiments, in the first device as described above that includes a first lens and a self-contained electronics module that contains an electronic component and a dynamic optic that may comprise a fluid lens configured to provide at least a first optical power and a second optical power, and an electromagnet coupled to at least a portion of the dynamic lens, the optical add power of the dynamic optic may be based at least in part on whether current or voltage is supplied to the electromagnet.

In some embodiments, in the first device as described above that includes a first lens and a self-contained electronics module that contains an electronic component and a dynamic optic that may comprise a fluid lens configured to provide at least a first optical power and a second optical power, the dynamic optic may further include a flexible element that can form a plurality of shapes. In some embodiments, the dynamic optic may provide a plurality of optical add powers for a portion of the first device based at least in part on the shape of the flexible element. In some embodiments, the dynamic optic may further include a fluid and a fluid holding element, where the fluid may be disposed within the fluid holding element. The fluid holding element may have a peripheral edge, and the shape of the flexible element may be based at least in part on the amount of force applied to at least a portion of the peripheral edge of the fluid holding element. In some embodiments, the self-contained electronics module may further contain an electromagnet, where the amount of force applied to the peripheral edge of the fluid holding element may be based at least in part on the amount of current or voltage supplied to the electromagnet. In some embodiments, the electromagnet may be disposed around at least a portion of the peripheral edge of the fluid holding element.

In some embodiments, in the first device as described above that includes a first lens and a self-contained electronics module that contains an electronic component, an electromagnet and a dynamic optic, where the dynamic optic may comprise a fluid lens having flexible element, a fluid, and a fluid holding element having a peripheral edge, the fluid disposed in the fluid holding element may apply a first force to a first portion of the flexible element when a current or voltage is supplied to the electromagnet and a second force to the first portion of flexible element when a current or voltage is not supplied to the electromagnet. The first and the second force may be different.

In some embodiments, in the first device as described above that includes a first lens and a self-contained electronics module that contains an electronic component, an electromagnet and a dynamic optic, where the dynamic optic may comprise a fluid lens having flexible element, a fluid, and a fluid holding element having a peripheral edge, the fluid holding element may include a first region. In some embodiments, fluid may be removed from the first region of the fluid holding element when a current or voltage is not supplied to the electromagnet, and fluid may be applied to the first region of the fluid holding element when a current or voltage is supplied to the electromagnet. In some embodiments, the optical add power of the dynamic optic may be increased when fluid is applied to the first region of the fluid holding element, and the optical add power of the dynamic optic may be decreased when fluid is removed from the first region of the fluid holding element.

In some embodiments, in the first device as described above that includes a first lens and a self-contained electronics module that contains an electronic component and a dynamic optic that may comprise a fluid lens configured to provide at least a first optical power and a second optical power, the dynamic optic may include a first lens component having a first surface and a second surface, a second lens component comprising a flexible element, and a fluid. In some embodiments, the fluid may be disposed and/or applied between at least a portion of the first lens component and at least a portion of the second lens component.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, and a fluid that may be applied between the first and the second lens component, a portion of the flexible element of the second lens component may have a first shape when a first amount of fluid is disposed between the first surface of the first lens component and the portion of the flexible element of the second lens component. In some embodiments, the portion of the flexible element of the second lens component may have a second shape when a second amount of fluid is disposed between the first surface of the first lens component and the portion of the flexible element of the second lens component. In some embodiments, the dynamic optic may provide a first optical add power when the portion of the flexible element of the second lens component has the first shape, and the dynamic optic may provide a second optical add power when the portion of the flexible element of the second lens component has the second shape.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, and a fluid that may be applied between the first and the second lens component, where a portion of the flexible element of the second lens component may have a first shape or a second shape based on the amount of fluid that is disposed between the first surface of the first lens component and the portion of the flexible element of the second lens component, the self-contained electronics module may contain an electromagnet. The electromagnet may be configured to apply or remove fluid disposed between the first surface of the first lens component and a portion of the flexible element of the second lens component based on the current or voltage supplied to the electromagnet.

In some embodiments, in the first device as described above that includes a first lens and a self-contained electronics module that contains an electronic component and a dynamic optic that comprises a fluid lens configured to provide at least a first optical power and a second optical power, where the dynamic optic may include a flexible element that can form a plurality of shapes, and wherein the dynamic optic provides a plurality of optical add powers for a portion of the first device based at least in part on the shape of the flexible element, the dynamic optic may further include a fluid and a fluid cavity. The fluid may be applied and removed from the fluid cavity and the shape of the flexible element may be based at least in part on the amount of fluid that is disposed within the fluid cavity. In some embodiments, the dynamic optic may further include an electromagnet. The amount of fluid that is disposed within the fluid cavity may be based, at least in part, on the amount of current or voltage supplied to the electromagnet. In some embodiments, the fluid may be applied to the fluid cavity when a current or voltage is supplied to the electromagnet, and the fluid may be removed from the fluid cavity when current or voltage is not supplied to the electromagnet. In some embodiments, the fluid may be removed from the fluid cavity when a current or voltage is supplied to the electromagnet, and fluid may be applied to the fluid cavity when current or voltage is not supplied to the electromagnet. In some embodiments, the optical add power of the dynamic optic may be increased when fluid is applied to the fluid cavity, and the optical add power of the dynamic optic may be decreased when fluid is removed from the fluid cavity. In some embodiments, the optical add power of the dynamic optic may be decreased when fluid is applied to the fluid cavity, and the optical add power of the dynamic optic may be increased when fluid is removed from the fluid cavity.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, and fluid that may be applied between the first and the second lens component, the dynamic optic may further include a fluid holding element configured to receive and apply the fluid from between the first and the second lens components. In some embodiments, the fluid holding element may be configured to have a shape that is based, at least in part, on a force applied to the fluid holding element. The amount of fluid that is applied or received from between the first and the second lens components may be based at least in part on the shape of the fluid holding element. In some embodiments, the fluid holding element may comprise a bladder.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, a fluid that may be applied between the first and the second lens component, and a fluid holding element, the self-contained electronics module may further include an electromagnet that may be configured to apply a force to the fluid holding element when current or voltage is supplied to the electromagnet. In some embodiments, the fluid holding element may comprise the electromagnet or a portion thereof. In some embodiments, the electromagnet may comprise magnetic material deposited as a layer on the fluid holding element. In some embodiments, the material of the electromagnet may comprise a ferromagnet. In some embodiments, the layer of magnetic material may have a thickness that is between approximately 1 and 5 microns. In some embodiments, the thickness of the layer may be between approximately 2 and 3 microns. In some embodiments, the material of the electromagnet may comprise anyone of, or some combination of: Mn doped ZnO layers; Yttrium Iron Garnet (YIG) layers; and La_{0.3}A_{0.7}MnO₃, where A may be Ba²⁺, Ca²⁺, or Sr²⁺. In some embodiments, in the first device as describe above, the electromagnet may include a first component and a second component. The first component or the second component of the electromagnet may be configured so as to magnetize when an electrical field is applied across each component. The first and the second components of the electromagnet may be configured to move relative to one another when magnetized.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, a fluid that may be applied between the first and the second lens component, and a fluid holding element, where the self-contained electronics module contains an electromagnet having a first component and a second component, at least a portion of the fluid holding element may be disposed between the first component and the second component of the electromagnet. The first component and the second component of the electromagnet may be at a first distance when no voltage or current is supplied to the electromagnet; and at a second when a first voltage or current is supplied to the electromagnet, where the first distance may be different than the second distance.

In some embodiments, in the first device as described above that includes a first lens and a self-contained electronics module that contains an electronic component and a dynamic optic configured to provide at least a first optical power and a second optical power, where the dynamic optic may comprise a fluid lens, the first device may further include a contact lens matrix. In some embodiments, the contact lens matrix may include a first surface and a second surface, where the first surface and the second surface may be disposed so as to create a first region between them. The self-contained electronics module may be disposed within the first region.

In some embodiments, in the first device as described above that includes a first lens and a self-contained electronics module that contains an electronic component and a dynamic optic configured to provide at least a first optical power and a second optical power, where the dynamic optic may comprise a fluid lens, the dynamic optic may provide a portion of a near distance optical power for a wearer when activated. The first device may provide a far distance optical power for a wearer when the dynamic optic is not activated. In some embodiments, the dynamic optic may provide an optical add power of at least 0.5 diopters when activated. In some embodiments, the dynamic optic may provide an optical add power of at least 1.0 diopter when activated. In some embodiments, the dynamic optic may provide an optical add power of at least 2.0 diopters when activated. In some embodiments, the near distance optical power and the far distance optical power may each be focused on the retina at different times.

In some embodiments, in the first device as described above that may include a first lens and a self-contained electronics module that contains an electronic component and a dynamic optic configured to provide at least a first optical power and a second optical power, where the dynamic optic may comprise a fluid lens, and where the self-contained electronics module may contain a power supply; a controller; and/or a sensing mechanism, the self-contained electronics module may further include a charging module that is configured to charge the power source. In some embodiments, the charging module may be configured to charge the power source using induction or kinetic energy. In some embodiments, the charging module may include at least one induction coil that is electrically coupled to the power source. In some embodiments, the induction coil may be configured to remotely charge the power supply.

In some embodiments, in the first device as described above that includes a first lens and a self-contained electronics module that contains an electronic component and a dynamic optic configured to provide at least a first optical power and a second optical power, where the dynamic optic may comprise a fluid lens, and where the self-contained electronics module contains a power supply, the power supply may comprise a battery. In some embodiments, the power supply may comprise a capacitor.

In some embodiments, in the first device as described above that includes a first lens and a self-contained electronics module that contains an electronic component and a dynamic optic configured to provide at least a first optical power and a second optical power, where the dynamic optic may comprise a fluid lens, and where the self-contained electronics module contains a controller, the controller may comprise a micro application-specific integrated circuit (ASIC).

In some embodiments, in the first device as described above that includes a first lens and a self-contained electronics module that contains an electronic component and a dynamic optic configured to provide at least a first optical power and a second optical power, where the dynamic optic may comprise a fluid lens, and where the self-contained electronics module may contain a sensing mechanism, the sensing mechanism may comprise one or more photodiodes. In some embodiments, the sensing mechanism may determine whether an eye lid is closed and/or how long the eye lid has been closed. In some embodiments, the sensing mechanism may electrically transmit a signal to a controller based on the determination of how long the eye lid has been closed. In some embodiments, the sensing mechanism may measure the amount of light that is reflected out of the eye.

In some embodiments, in the first device as described above includes a first lens and a self-contained electronics module that contains an electronic component and a dynamic optic configured to provide at least a first optical power and a second optical power, where the dynamic optic may comprise a fluid lens, and where the self-contained electronics module contains a power supply, the first device may further include an inductive coil configured to charge the power supply.

In some embodiments, in the first device as described above that includes a first lens and a self-contained electronics module that contains an electronic component and a dynamic optic configured to provide at least a first optical power and a second optical power, the first device may comprise a contact lens.

In some embodiments, in the first device as described above that includes a first lens and a self-contained electronics module that contains an electronic component and a dynamic optic configured to provide at least a first optical power and a second optical power, the dynamic optic may comprise any one of, or some combination of: a diffractive optic; a pixilated optic; a refractive optic; a tunable liquid crystal optic; a shaped liquid crystal layer; a shaped liquid layer; a liquid lens; and/or a conformal liquid lens.

In some embodiments, in the first device as described above that includes a first lens and a self-contained electronics module that contains an electronic component and a dynamic optic configured to provide at least a first optical power and a second optical power, the self-contained electronics module may have a thickness that is less than approximately 200 microns. In some embodiments, the self-contained electronics module may have a thickness that is between approximately 15 and 150 microns. In some embodiments, the self-contained electronics module may have a thickness that is between approximately 65 and 90 microns thick.

In some embodiments, a first device may be provided. The first device may include a self-contained electronics module having a thickness that is less than approximately 125 microns. The self-contained electronics module may further include a dynamic optic (or portion thereof) that may be configured to provide at least a first optical power and a second optical power, where the first optical power is different than the second optical power. In some embodiments, the electronics module may have a thickness that is less than approximately 90 microns. In some embodiments, the electronics module may have a thickness that is less than approximately 60 microns.

In some embodiments, in the first device as described above having a self-contained electronics module that includes a dynamic optic, where the self-contained electronics module has a thickness that is less than approximately 125 microns, the dynamic optic may comprise a fluid lens.

In some embodiments, in the first device as described above having a self-contained electronics module that includes a dynamic optic, where the self-contained electronics module has a thickness that is less than approximately 125 microns, the self-contained electronics module may contain one or more micro nanotubes. In some embodiments, the self-contained electronics module may contain an electromagnet.

In some embodiments, in the first device as described above having a self-contained electronics module that contains a dynamic optic, where the self-contained electronics module has a thickness that is less than approximately 125 microns, the dynamic optic may comprise any one of, or some combination of: a diffractive optic; a pixilated optic; a refractive optic; a tunable liquid crystal optic; a shaped liquid crystal layer; a shaped liquid layer; a fluid lens; or a conformal liquid lens.

In some embodiments, in the first device as described above having a self-contained electronics module that contains a dynamic optic, where the self-contained electronics module has a thickness that is less than approximately 125 microns, the dynamic optic may be discretely switchable between the first optical power and the second optical power. In some embodiments, the dynamic optic may be continuously tunable between the first optical power and the second optical power.

In some embodiments, in the first device as described above having a self-contained electronics module that contains a dynamic optic, where the self-contained electronics module has a thickness that is less than approximately 125 microns, the first device may comprise a contact lens or an intraocular lens.

In some embodiments, a first contact lens may be provided. The first contact lens may include a sealed self-contained electronic module. The sealed self-contained electronic module may include a dynamic optic.

In some embodiments, in the first contact lens as described above that includes a sealed self-contained electronic module that comprises a dynamic optic, the dynamic optic may be that of a diffractive optic. In some embodiments, the dynamic optic may be that of a refractive optic. In some embodiments, the dynamic optic may be that of a liquid optic. In some embodiments, the dynamic optic may be that of a tunable liquid crystal. In some embodiments, the dynamic optic may be that of a shaped liquid crystal optic. In some embodiments, the dynamic optic may be that of a Fresnel optic.

In some embodiments, in the first contact lens as described above that includes a sealed self-contained electronic module that comprises a dynamic optic, where the dynamic optic comprises a liquid optic, the liquid optic may change optical power by way of an electronic magnet. In some embodiments, the electronic magnet may comprise of a deposition coating.

In some embodiments, in the first contact lens as described above that includes a sealed self-contained electronic module that comprises a dynamic optic, the self-contained electronic module may be sealed in glass.

In some embodiments, in the first contact lens as described above that includes a sealed self-contained electronic module that comprises a dynamic optic, the self-contained electronic module may be charged remotely.

In some embodiments, in the first contact lens as described above that includes a sealed self-contained electronic module that comprises a dynamic optic, the self-contained electronic module may be charged by one of induction or kinetic energy. In some embodiments, where the module is charged by induction, the inductive charger may be that of one of: a contact lens case; an eye mask; or eyeglasses.

In some embodiments, in the first contact lens as described above that includes a sealed self-contained electronic module that comprises a dynamic optic, the self-contained electronic module may be stabilized so as to reduce rotation.

In some embodiments, in the first contact lens as described above that includes a sealed self-contained electronic module that comprises a dynamic optic, the first contact lens may include a dynamic optic and a central aspheric optical power region.

In some embodiments, in the first contact lens as described above that includes a sealed self-contained electronic module that comprises a dynamic optic, the first contact lens may be capable of correcting for the distance optical power of a wearer and separately the near optical power of the wearer, and whereby the distance and the near optical power may each be focused on the retina at different times.

Embodiments may provide a dynamic focusing lens. The dynamic focusing lens may comprise a contact lens or an intraocular lens that includes a dynamic optic and an electronic component. The dynamic optic may comprise a fluid lens. In some embodiments, the dynamic focusing lens may comprise a self-contained electronics module that may be inserted into (or otherwise be disposed within) the intraocular lens or a contact lens (or components thereof). The sealed self-contained electronics module may contain the dynamic optic (e.g. a dynamic lens) that may provide a changeable optical power to a portion of the intraocular lens or contact lens, such that when activated, a wearer of the dynamic focusing lens may be provided with a different optical power in comparison to when the dynamic optic is not activated. For instance, the dynamic optic may provide plus optical power corresponding to a wearer's near vision prescription when activated. The host lens—e.g. the contact lens or the intraocular lens—and/or the self-contained electronics module that may contain the dynamic focusing lens in some embodiments, may comprise other components that may be related to the operation of the dynamic optic, such as a power source, controller, sensors, etc. The components and/or the dynamic optic may be configured, in some embodiments, so as to reduce the overall size of the device such that it may be comfortably worn either as a contact lens or an intraocular lens. In some embodiments comprising a self-contained electronics module, the electronics module may be fabricated in a separate process from the other components of the dynamic focusing lens (e.g. in a separate process than the contact lens matrix) and may be inserted into, or otherwise disposed within, the host lens in a separate process. The self-contained electronics module may have a thickness that is less than approximately 125 microns in some embodiments, which may correspond to thickness that may be preferred such that the dynamic focusing lens may be comfortably worn by a wearer.

In this regard, embodiments may provide a contact lens or an intraocular lens that comprises a dynamic optic, which may comprise any suitable component or components such that the focal length of at least a portion of the device may be changed dynamically. The change may be a discrete switch between two optical powers (e.g. “ON” or “OFF”), or the dynamic optic may be tunable such that the optical power may be continuously varied. In some embodiments, the dynamic optic may comprise a fluid lens, where the fluid may be used to change the optical power provided by the dynamic optic (e.g. by changing the shape of a membrane, providing additional material (e.g. a fluid) having a refractive index in the optical path of light, masking/unmasking optical features of a substrate, preventing/permitting conformance of a membrane with an optical feature, etc.). In some embodiments, the position, amount, and/or pressure of the fluid may be controlled through the use of one or more electronic components, such as an electromagnet(s). For example, by applying current or voltage to an electromagnet, the electromagnet may exert a force on another magnetic material (such as another electromagnet or a permanent magnet or metal material). This force may be used in some instances to apply or remove fluid from an area of the fluid lens.

### BRIEF DESCRIPTION OF THE DRAWINGS

FIG. 1 shows a front view of an exemplary dynamic changeable focus lens in accordance with some embodiments.

FIG. 2 shows a front view of an exemplary dynamic changeable focus lens in accordance with some embodiments.

FIG. 3 shows a front view of an exemplary dynamic changeable focus lens in accordance with some embodiments.

FIG. 4 shows a front view of an exemplary dynamic changeable focus lens in accordance with some embodiments.

FIG. 5 shows a side view of an exemplary dynamic changeable focus lens in accordance with some embodiments.

FIG. 6 shows a side view of an exemplary dynamic changeable focus lens in accordance with some embodiments.

FIG. 7 shows a side view of an exemplary dynamic changeable focus lens in accordance with some embodiments.

FIG. 8 shows a side view of an exemplary dynamic changeable focus lens in accordance with some embodiments.

FIG. 9 shows a side view of an exemplary dynamic changeable focus lens in accordance with some embodiments.

FIG. 10 shows a side view of an exemplary dynamic changeable focus lens in accordance with some embodiments.

FIG. 11 shows a side view of an exemplary dynamic changeable focus lens in accordance with some embodiments.

FIG. 12 shows a side view of an exemplary dynamic changeable focus lens in accordance with some embodiments.

FIG. 13(a) illustrates the I_{D}-V_{G} curve of a P-doped NWFET at V_{D}=−3V.

FIG. 13(b) shows the I_{D}-V_{D} curves of P-doped NWFET with gate voltage (V_{G}) at −5, −2.5, 0, 2.5, and 5V.

### DETAILED DESCRIPTION OF THE INVENTION

Embodiments described herein may provide a device or apparatus, such as a contact lens or intraocular lens, which includes a dynamic optic (such as a fluid lens) and an electronic component that may drive the dynamic optic such that at least a portion of the device may provide a dynamic optical power for a wearer. Some embodiments may also include a self-contained electronics module that comprises the dynamic optic (or a portion thereof) and/or the electronic component. The self-contained electronics module may have a thickness such that it may be utilized within a contact lens or an intraocular lens, such as a thickness that is less than 125 microns. The self-contained electronics module may contain components for utilizing the dynamic lens, such as a power source, sensor, and/or a controller.

The dynamic optic may utilize any suitable method of changing the focal length of an optical device (or a portion thereof). For example, as noted above some embodiments of a dynamic optic may comprise a fluid lens that may provide optical add power based on the amount and/or position of a fluid within the dynamic optic. The fluid amount and/or position may be controlled using any suitable means, including for example by use of one or more electromagnets. However, embodiments are not so limited. For example, some embodiments may utilize other dynamic optics such as those that comprise a tunable liquid crystal optic; a shaped liquid crystal layer; a shaped liquid layer; any type of liquid lens, etc. The dynamic optic may be used in combination with various other optical components, including fixed or rigid optical components (or other dynamic optical components) so as to provide the ability for the device to obtain multiple optical powers reliably and accurately (and to have different optical zones that provide different optical powers). Embodiments of the device may thereby provide some of the benefits of a dynamic lens for use in an intraocular lens or a contact lens. Moreover, in some embodiments, the use of a self-contained electronics module may reduce manufacturing complexity and cost because, for instance, the electronics module may be fabricated separately from the other components of the apparatus, and the electronics module may be inserted into one or more other components (or the other components may be formed around the electronics module), such as a contact lens matrix.

Some terms that are used herein are described in further detail as follows:

As used herein, “add power” may refer to the optical power added to the far distance viewing optical power which is required for clear near distance viewing in a dynamic lens. For example, if an individual has a far distance viewing prescription of −3.00D with a +2.00D add power for near distance viewing then the actual optical power for near distance is −1.00D. Add power may sometimes be referred to as plus power. Add power may be further distinguished by referring to “near viewing distance add power,” which refers to the add power in the near viewing distance portion of the optic and “intermediate viewing distance add power” may refer to the add power in the intermediate viewing distance portion of the optic. Typically, the intermediate viewing distance add power may be approximately 50% of the near viewing distance add power. Thus, in the example above, the individual would have +1.00D add power for intermediate distance viewing and the actual total optical power in the intermediate viewing distance portion of the optic is −2.00D.

As used herein, the term “approximately” may refer to plus or minus 10 percent, inclusive. Thus, the phrase “approximately 10 mm” may be understood to mean from 9 mm to 11 mm, inclusive.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps. For instance, in describing a method, “comprising” indicates that the claim is open-ended and allows for additional steps. In describing a device, “comprising” may mean that a named element(s) may be essential for an embodiment, but other elements may be added and still form a construct within the scope of a claim. In contrast, the transitional phrase “consisting of” excludes any element, step, or ingredient not specified in a claim.

As used herein, “coupled” may refer to any manner of connecting two components together in any suitable manner, such as by way of example only: attaching (e.g. attached to a surface), disposing on, disposing within, disposing substantially within, embedding within, embedded substantially within, etc. “Coupled” may further comprise fixedly attaching two components (such as by using a screw or embedding a first component into a second component during a manufacturing process), but does not so require. That is, two components may be coupled temporarily simply by being in physical contact with one another. Two components are “electrically coupled” or “electrically connected” if current can flow from one component to another. That is, the two components do not have to be in direct contact such that current flows from the one component directly to the other component. There may be any number of other conductive materials and components disposed electrically between two components “electrically coupled” so long as current can flow there between.

As used herein, a “conductive path” may refer to a continuous path for which electrons (i.e. current) may flow from one point to another. The conductive path may comprise one component, or more than one component.

As used herein, a “dynamic lens” or a “dynamic optic” may refer to a lens or optical component with an optical power which is alterable with the application of electrical energy, mechanical energy, or force. Either the entire lens or component may have an alterable optical power, or only a portion, region or zone of the lens or component may have an alterable optical power. The optical power of such a lens or component may be dynamic or tunable such that the optical power can be switched or tuned between two or more optical powers. The switching may comprise a discrete change from one optical power to another (such as going from an “OFF” or inactive state to an “ON” or active state) or it may comprise continuous change from a first optical power to a second optical power, such as by varying the amount of electrical energy to a dynamic element. As used herein, one of the optical powers may be that of substantially no optical power (i.e. Plano). Examples of dynamic lenses include electro-active lenses (such as those that utilize liquid crystals), meniscus lenses, fluid lenses, movable dynamic optics having one or more components, gas lenses, and membrane lenses having a member capable of being deformed. A dynamic lens may also be referred to as a dynamic optic, a dynamic optical element, a dynamic optical zone, dynamic power zone, or a dynamic optical region.

As used herein, an “electromagnet” may refer to a type of magnet in which the magnetic field is produced by the flow of electric current. The magnetic field may disappear when the current is turned off.

As used herein, a “far viewing distance” may refer to the distance to which one looks, by way of example only, when viewing beyond the edge of one's desk, when driving a car, when looking at a distant mountain, or when watching a movie. This distance is usually, but not always, considered to be approximately 32 inches or greater from the eye the far viewing distance may also be referred to as a far distance and a far distance point.

As used herein, a “fluid holding element” may refer to any component that may retain (or otherwise contain) a fluid. For instance, a fluid holding element may comprise a reservoir where excess fluid (or fluid that is not in use) may be held for later use. An example of a fluid container element may comprise a bladder—which refers to a device that may increase or decrease the amount of fluid that is held therein by, for example, changing its shape (e.g. expanding or contracting).

As used herein, an “intermediate viewing distance” may refer to the distance to which one looks, by way of example only, when reading a newspaper, when working on a computer, when washing dishes in a sink, or when ironing clothing. This distance is usually, but not always, considered to be between approximately 16 inches and approximately 32 inches from the eye. The intermediate viewing distance may also be referred to as an intermediate distance and an intermediate distance point.

As used herein, a “lens” may refer to any device or portion of a device that causes light to converge or diverge. The device may be static or dynamic. A lens may be refractive or diffractive. A lens may be concave, convex or plano on one or both surfaces. A lens may be spherical, cylindrical, prismatic or a combination thereof. A lens may be made of optical glass, plastic or resin. A lens may also be referred to as an optical element, an optical zone, an optical region, an optical power region or an optic. It should be noted that within the optical industry a lens can be referred to as a lens even if it has zero optical power.

As used herein, a “near viewing distance” may refer to the distance to which one looks, by way of example only, when reading a book, when threading a needle, or when reading instructions on a pill bottle. This distance is usually, but not always, considered to be between approximately 12 inches and approximately 16 inches from the eye. The near viewing distance may also be referred to as a near distance and a near distance point.

As used herein, “optical communication” may refer to the condition whereby two or more optics of given optical power are aligned in a manner such that light passing through the aligned optics experiences a combined optical power equal to the sum of the optical powers of the individual elements.

As used herein, a “patterned electrode” may refer to electrodes utilized in an electro-active lens such that with the application of appropriate voltages to the electrodes, the optical power created by the liquid crystal is created diffractively regardless of the size, shape, and arrangement of the electrodes. For example, a diffractive optical effect can be dynamically produced within the liquid crystal by using concentric ring shaped electrodes.

As user herein, a “pixilated electrode” may refer to electrodes utilized in an electro-active lens that are individually addressable regardless of the size, shape, and arrangement of the electrodes. Furthermore, because the electrodes are individually addressable, any arbitrary pattern of voltages may be applied to the electrodes. For example, pixilated electrodes may be squares or rectangles arranged in a Cartesian array or hexagons arranged in a hexagonal array. Pixilated electrodes need not be regular shapes that fit to a grid. For example, pixilated electrodes may be concentric rings if every ring is individually addressable. Concentric pixilated electrodes can be individually addressed to create a diffractive optical effect.

As used herein, a “static lens” or ‘static optic” may refer to a lens having an optical power which is not alterable with the application of electrical energy, mechanical energy or force. Examples of static lenses include spherical lenses, cylindrical lenses, Progressive Addition Lenses, bifocals, and trifocals. A static lens may also be referred to as a fixed lens. A lens may comprise a portion that is static, which may be referred to as a static power zone, segment, or region.

As used herein, a “self contained electronics module” may refer to a container or module that comprises some or all of the components that may be used to provide dynamic optical power for a device such as an intraocular lens or a contact lens. That is, for instance, a self-contained electronics module may comprise some or all of the electronic components such that the module may stand alone and may function as a dynamic optic (e.g. providing more than one optical power) without the use of any other components, and may be inserted, coupled to, optically coupled to, or otherwise disposed with respect to any other components or optical devices so as to provide this functionality to a wearer. In some embodiments, the use of a self-contained electronics module may provide the ability to separately manufacture the electronics module (including a dynamic optic contained therein) so as to be able to “insert” the module into an intraocular lens or contact lens matrix (or outer contact lens shell), or form the contact lens around the self-contained electronics module. In some embodiments, the use of a self-contained electronics module may also serve to electrically isolate one or more electronic components.

As noted above, when describing dynamic optics (e.g. dynamic lenses), it is contemplated, by way of example only, that this may include electro-active lenses, fluid lenses, gas lenses, membrane lenses, mechanical movable lenses, etc. Examples of such lenses can be found in Blum et al. U.S. Pat. Nos. 6,517,203, 6,491,394, 6,619,799, Epstein and Kurtin U.S. Pat. Nos. 7,008,054, 6,040,947, 5,668,620, 5,999,328, 5,956,183, 6,893,124, Silver U.S. Pat. Nos. 4,890,903, 6,069,742, 7,085,065, 6,188,525, 6,618,208, Stoner U.S. Pat. No. 5,182,585, and Quaglia U.S. Pat. No. 5,229,885. For simplicity, many of the embodiments discussed below may reference the use of electro-active lenses or dynamic optics. However, this should not be construed as limiting in any way, as the principles embodiments may have equal applicability to these other types of dynamic lenses.

As noted above, intraocular lenses and contact lenses generally provide a sufficient means of vision correction for myopes, hyperopes and astigmats (i.e. individuals afflicted with any of the corresponding vision impairments) and are widely used for vision correction by younger people. This appears to be especially true in developed countries, where individuals may have better access to contact lenses and/or intraocular lenses (which may be more expensive and/or more difficult to obtain in less developed countries). In general, intraocular lenses and/or contact lenses may not be comfortably used by presbyopes (i.e. individuals suffering from presbyopia), because, for instance, presbyopes typically require an added plus optical power (to correct for accommodation deficiency) only when viewing near objects, and may require a second optical power for intermediate or far distance viewing. Currently, the only commercially available contact and intraocular lenses that attempt to provide correction of presbyopia do so by utilizing a split optic—i.e. one optic for far vision and one optic for near vision—which tends to create a double image on the retina at all object distances. This may be distracting to a wearer and/or may impair the wearer's vision. Although there may be some development on intraocular lenses that utilize natural muscular accommodating forces to change the shape of a lens, these types of lenses (that do not generally comprise an electronic component) may have significant drawbacks, such as an inability to reliably control the optical power provided by the lens, an increased expense in both the manufacturing and/or customization the lenses to work in a user's eye, etc.

Therefore, in some instances, there may be a need to provide a dynamic optic (e.g. switchable) in an intraocular lens or a contact lens that reliably provides an additional plus optical power (e.g. up to 3.5 diopters (D), which may generally correspond to the typical range of the optical add powers needed by most presbyopes, although greater optical add powers may also be achieved). The additional optical plus power could be provided in response to a need by a viewer (e.g. in response to a signal from a viewer (or in response to a viewer's actions) that indicates he would like to view, or is viewing, an object at a near distance). An intraocular or contact lens with a dynamic optic may have numerous uses, including, by way of example only, correction of presbyopia, treatment of eye diseases such as macular degeneration and corneal dystrophies, such as dehiscence that may be caused as a side effect of LASIK surgery, or corneal abnormalities such as keratoconus. Moreover, in some embodiments, the use of an electronic component to drive and/or control the dynamic optic may provide reliability and consistency in providing the dynamic optical powers, as well as increased control by the wearer (particularly in comparison with devices that may rely on the muscular accommodating forces of a user's eye).

However, the environment of an intraocular or contact lens may present certain challenges to the development of a dynamic optic, particularly for those that may comprise one or more electronic components. For example, some of the issues presented by such an environment may include: the small size of the components that may be used; a limited sagittal space; a need for compatibility with the overall function of a contact or intraocular lens; a need for biocompatibility of all materials that will come into contact with ocular tissue, etc. The inventors have found that several mechanisms of dynamic optics may be adapted for contact or intraocular lens applications, such as, by way of example only: electro-active focusing elements or apertures, or combinations thereof, deploying liquid crystal materials; high refractive index fluid lens modules that may translate in the anterior/posterior direction; fluid lenses that can dynamically change curvature, etc. For example, the inventors have found that in some embodiments, fluid lenses may be utilized in the relatively limited available space in contact lens or intraocular lens embodiments. However, any suitable dynamic optic may be used in some embodiments provided herein.

In general, some embodiments may comprise several elements so as to provide a dynamic intraocular lens or a contact lens. Some of those elements may include, for example: (1) a dynamic optical system; (2) an actuation system; (3) an energy supply system; (4) a signaling system; and/or (5) an on-board programmable logic controller that manages and reports on the functions of the system. In some embodiments, some or all of these components or systems may be built into a stand alone sealed subassembly (e.g. a self-contained electronic module). These components may then be integrated into a whole assembly within the self-contained electronic module, which may then be embedded into, or otherwise disposed within, the body of an intraocular or contact lens without significantly obscuring light path, or allowing leaching of non-biocompatible materials into the eye. That is, for instance, the self-contained electronics module and/or the components described above may be transparent, semi-transparent, and/or disposed so as to not be noticeable by a wearer.

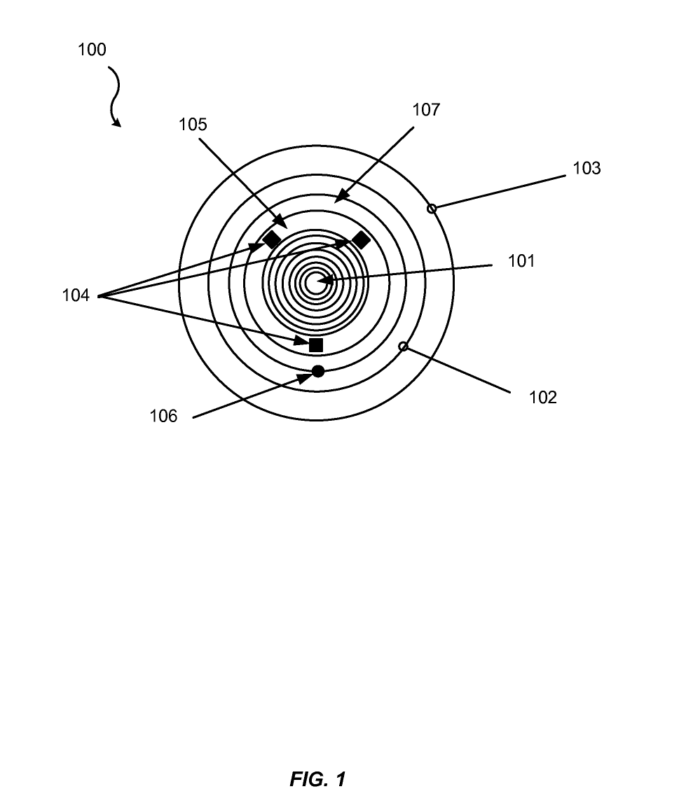

In some embodiments, a dynamic optic may include the use of an electro-active (EA) cell comprising a liquid crystal (LC) material. Example embodiments that may include a LC material are shown in FIGS. 1-4, 7-8, and 11-12 and are described in more detail below. This EA cell may provide a diffractive or a refractive optic, employing either a single or patterned electrode with a LC material that may be polarization insensitive (e.g. a cholesteric LC) or polarization sensitive material (e.g. nematic LC). The refractive optic may, for example, be a dynamic (e.g. switchable/tunable) Fresnel lens, and may be driven by pixilated or patterned electrodes and/or a shaped liquid crystal layer. In some embodiments, the diffractive optic may be a switchable diffractive optic that may be turned “ON” by creating a mismatch of the refractive index of the LC medium and the substrate so that, for instance, the dynamic optic remains a fail-safe device—e.g. the dynamic optic is turned “OFF” when the energy supply fails to operate properly.

In some embodiments, an EA cell may also be used to provide a dynamic aperture that enhances the depth of focus when viewing near objects. This may thereby provide superior acuity at intermediate distances (e.g. 0.5 to 2.0 meters). In some embodiments, a bistable LC material may be used, which may thereby reduce the energy requirement to maintain plus optical power in the device (that is, for instance, the dynamic optic may change its optical power when a current or voltage is applied, and will maintain this optical power until another voltage or current is applied). The dynamic optic may also be designed to provide tunability by, for instance, utilizing two or more EA cells that may be stacked (so as to be in optical communication) so that each cell may provide part or all of the total add power of the device (or a portion thereof) depending on the object distance. However, embodiments are not so limited, and tunability of the dynamic optic may be provided in any suitable way, including by utilizing patterned electrodes in which a specific subset of the electrodes can be electrically addressed to generate a partial add power. In some embodiments, an electronic controlled fluid lens may be utilized to achieve tunability (e.g. the optical add power of the dynamic lens may be based on the amount and/or position of a fluid, which may be continuously varied).

In some embodiments, the dynamic optic (or a portion thereof) may be in optical communication with an aspheric zone that may be radially symmetric (or asymmetric in some instances). The aspheric zone may have any suitable surface geometry and/or optical property (such as an index of refraction) so as to provide optical plus or minus power and may be located on any suitable optical component of the device (such as, for example, one an inner or outer surface of a host contact lens matrix or intraocular lens). In some embodiments, the aspheric add zone may have a surface geometry characterized by a variable negative spherical aberration, which may be provided to further enhance visual performance at intermediate object distances. That is, for instance, the negative optical power of the aspheric zone may be combined with the optical add power of the dynamic optic such that regions of the intraocular lens may have different optical add powers that may be better suited for different viewing distances. In some embodiments, one side of an optical element (e.g. the aspheric zone or a portion of the dynamic optic) may have a diffractive pattern that may be etched, molded, or embossed on a surface of the material. The diffractive patterns may also be applied in the form of a coating. As noted above, the aspheric zone may be disposed within the dynamic optic and/or may comprise another optical component of an intraocular lens (which may be in optical communication with the dynamic optic or a portion thereof).

In some embodiments comprising a self-contained electronics module that may contain a dynamic optic (or a portion thereof), one or more of the inner surfaces of the walls of the self-contained electronic module may be coated with indium tin oxide (ITO) and/or silicon dioxide (SiO₂), so as to provide insulation and/or conduction when and where needed. The inner surfaces of the walls of the self-contained electronics module may be further coated with a polyimide or a polysiloxane layer that serves as an alignment layer for the LC material (e.g. in embodiments where the dynamic optic comprises a LC layer). The self-contained electronics module may be sealed using any suitable method, including by using a welding process (such as heat sealing, laser welding, ultrasonic welding, etc.), or it may be sealed by using an adhesive bond. The sealing process may, in some instances, comprise the utilization of a transparent cap disposed over an opening of the module, which may then be coupled thereto using any suitable method, including those listed above.

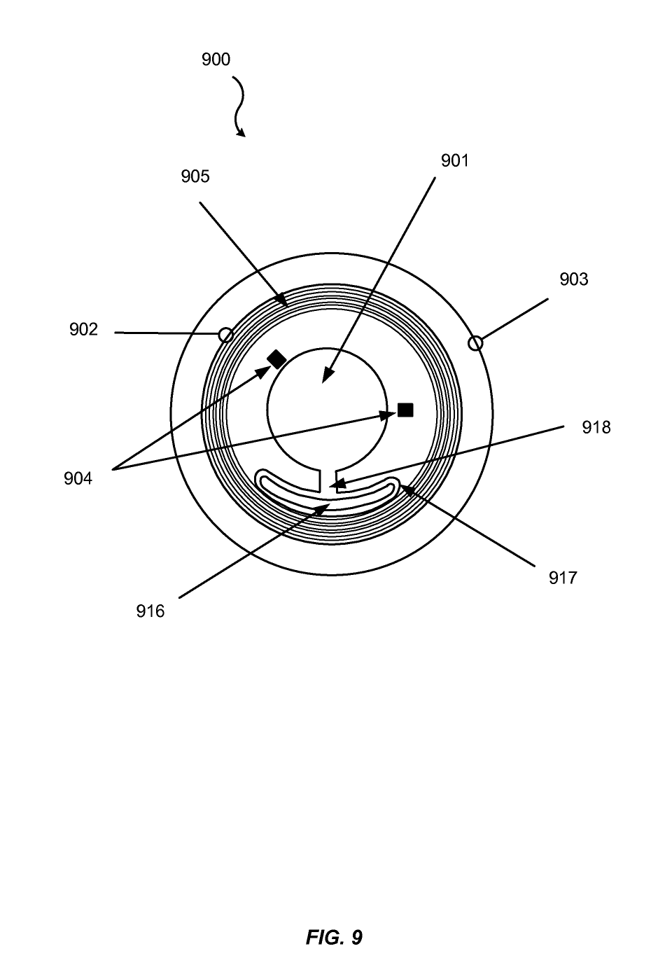

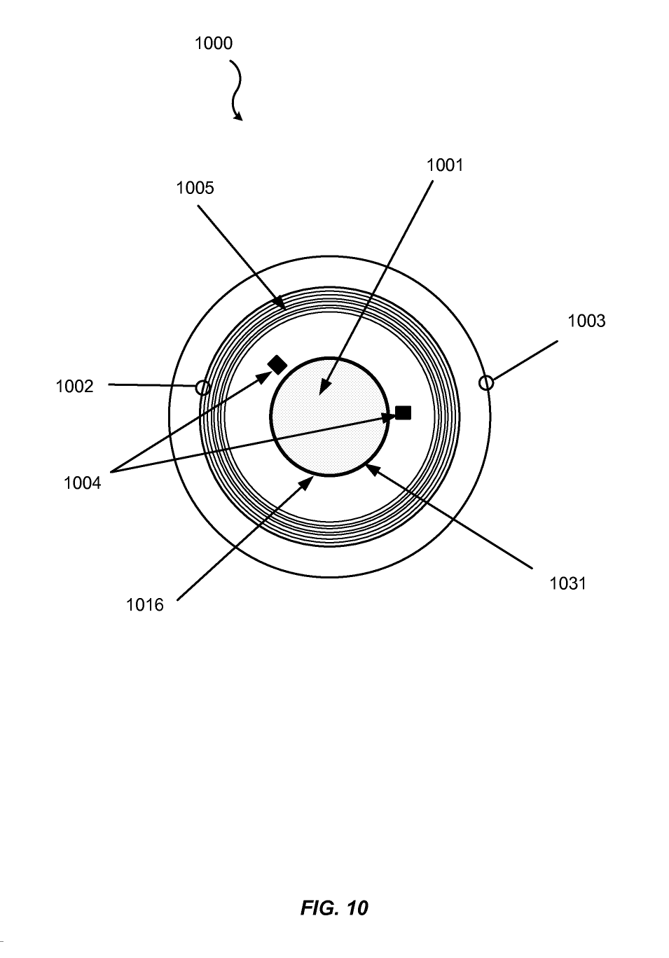

In some embodiments, the dynamic optic may comprise an electronic controlled fluid lens. For instance, in some embodiments, the focal length of the device may be changed by increasing or decreasing the convex curvature of the dynamic optic or a portion thereof (e.g. increasing or decreasing the curvature of a central optic, such as a portion of the dynamic optic comprising a membrane) by applying or removing fluid from a region of the dynamic lens. In some embodiments, the dynamic optic may be drive by one or more electronic components, such as an electromagnet that may be utilized to control a micro bladder that is operatively coupled to the central optic—e.g. the electromagnet when activated may press fluid into the central optic (e.g. an area comprising a membrane) to add positive power to the contact lens by, for instance, increasing the radius of curvature of the membrane or other flexible element. When removing the magnetic force, such as when current or voltage is not supplied to the electromagnet, the bladder may relax and the fluid may return into the bladder thereby causing the membrane (or other flexible element) to return to its resting shape. The resting shape of the flexible element may be configured to provide an optical power corresponding to the distance prescription of the wearer. In this manner, the central optic may be a refractive optic that is a component of a dynamic fluid lens. Example embodiments that may comprise some of these features are shown in FIGS. 9 and 10, and described in more detail below. It should be noted that although the exemplary embodiments illustrated in FIGS. 9 and 10 utilize an electronics module that comprises the dynamic optic, embodiments are not so limited (e.g. some embodiments of a contact lens or intraocular lens may utilize a fluid lens without comprising an electronics module). However, it may preferred in some embodiments that an self-contained electronics module may be utilized for some of the reasons noted above, including insulating the electronics component, preventing leakage of materials, reducing manufacturing costs, etc.

The inventors have found that the use of one or more electronic components may provide the advantages of a dynamic focusing lens, with increased reliability, responsive, and reduction in costs in comparison to current contact lenses and intraocular lenses. For example, the use of one or more electromagnets, electronically controlled bladders, etc. in some embodiments may provide some advantages over other methods and components that may be used to provide a dynamic optical power to a device. For instance, electromagnets may be relatively small, as they may comprise a thin layer of electromagnetic material and electrical connections to a power source. As noted above, utilizing components that have a small form factor may be advantageous, particularly in embodiments comprising an intraocular or contact lens where space may be limited. For instance, an electromagnet may comprise a layer of ferromagnetic material between approximately 2-3 microns thick. Moreover, for embodiments comprising a fluid lens, electromagnets may apply force to a fluid (or a component that holds a fluid) without necessarily using any moving parts or other mechanical (or electrical) components that (1) may be larger than a thin layer of electromagnetic material and may thereby utilize a larger amount of the limited space available in such embodiments; and/or (2) may be susceptible to damage or failure. That is, for instance, an electromagnet may continue to function so long as an electrical connection is provided to a power source. The inventors have also found that another advantage that the use of electromagnets may provide in some embodiments is that the amount of force applied by an electromagnet may be proportional (or at least may vary) based on the amount of current or voltage supplied to the electromagnet or a component thereof. Thus, taking for example of a fluid lens embodiment, the amount of fluid applied to, or removed from, an area or region of the dynamic optic may be continuously or variably controlled, which may provide for increased functionality and variability of the dynamic optic (and the device comprising the dynamic optic).

In some embodiments, where the dynamic optic comprises an electronic controlled fluid lens, the dynamic lens may comprise a conformal curvature design. That is, for example, the central optic of the dynamic lens may comprise a flexible element that may conform to a surface having a shape that provides an optical power when fluid is removed from (or applied to) a portion of the dynamic lens. For example, some embodiments may use an electronically controlled micro bladder to express liquid out of (e.g. remove) or apply liquid to the area of a central optic (e.g. a region of the dynamic lens that may provide the dynamic optic powers—i.e. the dynamic optical power region of the device) thereby causing a membrane (or other flexible element) to take the shape of a rigid substrate layer located adjacent to the membrane. The shape of the substrate may be such that, when the membrane conforms (or substantially conforms) to its surface, the dynamic lens provides a positive optical add power to the device (e.g. a contact lens or intraocular lens). When the force is removed (such as a magnetic force applied by an electromagnet) from the micro bladder, the bladder may relax and the liquid may be removed from (or may return to) the central optical area thus causing the membrane of the central optic to return to its resting shape (e.g. the shape whereby liquid is beneath the membrane or, in some embodiments, where there is no liquid beneath it). This resting position may be configured to provide the optical power needed by the wearer for distance viewing. Thus, in some embodiments, the central optic of the dynamic optic may comprise a refractive optic that is that of a liquid lens that conforms to the curvature of a substrate that is adjacent to the flexible element (e.g. a shaping membrane) when liquid is pumped into, or out of, the region. In some embodiments, the dynamic optic may further comprise a second substrate disposed directly opposite the first substrate such that the flexible element may conform to the second element when fluid is applied to the area of the central optic of the dynamic optic, and may conform to the first substrate when fluid is removed from the area of the central optic. An example of such a dynamic lens is described in detail in U.S. App. Ser. No. 13/050,974 filed on Mar. 18, 2011 to Blum et al. entitled “Dynamic Lens,” which is hereby incorporated by reference in its entirety.

It should be noted that although reference may be made to the “central optic” or “the area of the central optic,” it is not meant to imply that (or otherwise limit) the area must be located in the center of the dynamic optic or the intraocular lens. Indeed, the area of the central optic that may include a flexible element that changes shape or curvature to provide dynamic optical power may be located in any suitable location of the dynamic optic. However, it may be generally preferred in some embodiments that the area of the central optic that provides dynamic optical power be disposed in the center of an intraocular or contact lens because, unlike eyeglasses, a viewer typically tends to look though the center of an intraocular or contact lens when viewing objects at different distances. Example embodiments that comprise some of these features are shown in FIGS. 9 and 10, and described in more detail below.

Regardless of the type of dynamic optic utilized, embodiments provided herein may comprise a self-contained electronic module. In some embodiments, the self-contained electronics module may be made of, by way of example only, a thin sheet of glass or a biocompatible plastic material that may generally be impermeable to the components of the dynamic optic (such as materials that are impermeable to a liquid crystal material when the dynamic optic comprises a liquid crystal layer). The self-contained electronics module may have any suitable size and thickness, although it may preferred that the module comprise as small a size as possible given that it may be disposed in an intraocular or contact lens that will have a limited amount of space available. In this regard, the inventors have found that an electronics module that has a thickness that is less than approximately 120 microns may in general be thin enough such that the module may be disposed within a contact lens or intraocular lens and still be worn comfortably by a wearer. The “thickness” may refer to the dimension of the module that may be in the plane that is substantially perpendicular to the wearer's eye when the device is being worn. In general, the inventors have also found that it may be preferred in some embodiments that the electronics module have a thickness that may be as small as possible so that, for instance: (1) the overall size of the contact lens or the intraocular lens may be reduced, which may increase the comfort to a wearer; (2) additional material (such as contact lens matrix material) may be disposed between the surface of the contact lens or intraocular lens and the electronics module, thereby reducing the chances of exposure of the module (or the components therein) and/or reducing the possibility of damage to the electronics module; and (3) additional optical components (e.g. a static optic, such as an aspheric optical zone corresponding to a surface of the intraocular or contact lens, and/or dynamic optic) may be disposed in optical communication with the dynamic optic so as to provide for additional applicability/variability of the optical power of the device. In this regard, it may be preferred in some embodiments that the total thickness of the self-contained electronics module be in the range of approximately 17-120 microns (and more preferably in the range of approximately 65-90 microns), which may be thick enough so as to contain the components of the dynamic lens (and any other electronic components), while being thin enough to fit reasonably well within the structure of an intraocular lens such that it does not irritate or otherwise unreasonably affect the wearer or his vision.

For example, the inventors have found that in some embodiments, glass sheets as thin as approximately 25 microns may be used for walls of the self-contained electronic module; however, a preferred range of approximately 10-200 microns (more preferably in the range of approximately 25-50 microns) may be suitable for most purposes. The inventors have also found that a suitable refractive index for the sheets for most purposes may be in the range of approximately 1.45 to 1.75, (preferably in the range of approximately 1.50 to 1.70). One exemplary material that the inventors have found that may be used for the glass sheets is Borofloat glass, made by Zeiss®, which is generally both biocompatible and suitable for use in human implants. The inventors have also found that in some embodiments, plastic sheets as thin as approximately 5 microns (preferably in the range of approximately 5-200 microns, more preferably in the range of approximately 7-25 microns) may be utilized. Examples of such plastic materials include Polyfluorocarbons (such as PVDF or Tedlar manufactured by DuPont®), which the inventors have found may be drawn to this range of thickness and are also biocompatible and are generally impermeable to LC materials.

A device comprising a dynamic optic may comprise an actuation system for activating the dynamic lens so as to alter the focal length of a portion of the device. In this regard, any suitable actuation system may be used, and may be chosen based on the type of dynamic lens that the device comprises (e.g. whether using a liquid crystal layer, a fluid lens, etc.). For example, for dynamic lenses that comprises an electro-active cell that includes a liquid crystal layer, the electro-active cells may be activated by supplying a direct voltage to one more electrodes. In general, a larger thickness of the LC material may require a higher voltage to activate the dynamic lens. Moreover, as the thickness of the LC layer increases, the switching time of the dynamic lens may also increase (i.e. it may take longer for the focal length of the device to change). The inventors have found that for exemplary intraocular or contact lenses comprising such electronically controlled dynamic lenses, a suitable direct voltage supplied to the electro-active cell may be in the range of approximately 1.6V to 30V (and more preferably in the range approximately 3.0V to 15V, and even more preferably in the range of approximately 3.0V to 9.0V); however, as noted above, the precise voltage needed may vary based on the thickness and material used for the LC layer. For example, a 3-5 micron thick layer of a LC material in a switchable diffractive electro-active cell may require between approximately 3.5 and 6.0V of switching voltage to be applied, and will typically have a time constant of less than 50 msec (e.g. the time to change from one the focal length of a portion of the device from a first focal length to a second focal length).

A device comprising a dynamic optic may comprise a power source that may be used to activate the dynamic optic (or otherwise alter the optical power provided by the dynamic optic, such as by switching or tuning the optical power provided between two points). In general, any suitable power source may be used and may be chosen based on factors such as: the amount of space available; the amount of current or voltage needed to be supplied; the lifetime of the device (e.g. some intraocular lenses may be disposable, while others may be worn for a long period of time); price, etc. In some embodiments, the power source may comprise a primary battery, which may be used, for instance, with disposable contact lenses because they may not be recharged. In some embodiments, a rechargeable battery (such as a rechargeable Li-ion battery) or a capacitor may be used, for instance, in an intraocular or contact lens that may be used multiple times and/or for long periods of time. In some embodiments, the rechargeable batteries or capacitor may be recharged when the intraocular or contact lens is removed from the eye for cleaning purposes. However, embodiments are not so limited, and in some instances, the rechargeable battery or capacitor may be recharged when the lens is in the wearer's eye. For example, some embodiments may utilize a remote charging process, such as one that utilizes microwave radiation generated by a recharging system embedded in an eye mask or a pair of goggles. Some embodiments may utilize inductive charging to remotely recharge a battery or other energy storage device while an intraocular or contact lens is being worn by a wearer (e.g. some embodiments may use a magnetic element that moves along a microscopic tube of high surface conductivity—such as a nanowire—to generate electricity). A “nanowire” or “nanotube” may refer to a device or component having a nanostructure, with the diameter of the order of a nanometer (10⁻⁹ meters). In some instances, nanowires may be defined as structures that have a thickness or diameter constrained to tens of nanometers or less and an unconstrained length. At these scales, quantum mechanical effects may need to be considered. An example of device or apparatus that comprises nanotubes that to generate electric charge is shown and described in Hiroshi Somada, Kaori Hiraharat, Seiji Akita, and Yoshikazu Nakayamat, Linear Motor Comprising a Metallic Element within a Conductive Track, Nano Letters, Vol. 9, Issue 1, (14 Jan. 2009); pp 62-65, which is hereby incorporated by reference in its entirety. In some embodiments, nanowires may also be used to form one or more electrical connections between two components (such as between an electronic component and a power source or controller). The use of nanowires may be preferred in some instances because these components tend to have small form factor, which may reduce the size of the dynamic optic and/or a self-contained electronics module.

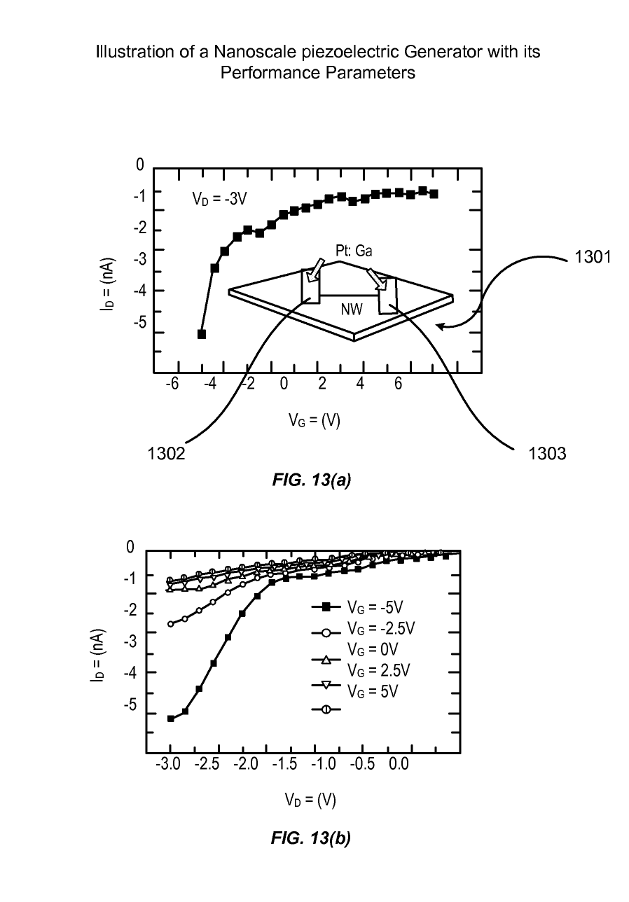

In some embodiments, piezoelectric power generators (e.g. materials that accumulate charge in response to applied mechanical stress) may be coupled to a rechargeable battery (which may function as an energy storage device) so to generate electricity while disposed in a wearer's eye. An example of a piezoelectric power generator is described in Ming-Pei Lu, Jinhui Song, Ming-Yen Lu, Min-Teng Chen, Yifan Gao, Lih-Juann Chen, and Zhong Lin Wang, Piezoelectric Nanogenerator Using p-Type ZnO Nanowire Arrays, Nano Letters, Vol. 9, Issue 3 at pp. 1223-1227 (11 Feb. 2009), which is hereby incorporated by reference in its entirety. An illustration of a Nanoscale piezoelectric generator with its performance parameters from Piezoelectric Nanogenerator Using p-Type ZnO Nanowire Arrays is shown in FIGS. 13(a)-(b). In particular, FIGS. 13(a) and (b) show the electrical characteristics of P-doped ZnO nanowire field effect transistor (NWFET). FIG. 13(a) illustrates the I_{D}-V_{G} curve of a P-doped NWFET at V_{D}=−3V. A schematic diagram of the NWFET is shown as 1301, which comprises electrodes 1302 and 1303 at both ends of a single nanowire (NW). In this example, the electrodes were deposited by focused ion beam (FIB). FIG. 13(b) shows the I_{D}-V_{D} curves of P-doped NWFET with gate voltage (V_{G}) at −5, −2.5, 0, 2.5, and 5V.

Although several examples of generating electricity (or otherwise remotely charging a battery disposed within an intraocular lens) are provided above, any suitable means may be utilized as may be understood by a person of ordinary skill in the art after reading this disclosure.

A device (such as a contact lens or intraocular lens) comprising a dynamic optic may include a sensing and/or communication component to determine whether to activate (or tune) the dynamic optic. In some embodiments, the sensing mechanism may be used to determine if the wearer is presently viewing an object at a near, intermediate, or far distance, and may signal a controller to activate or deactivate the dynamic optic so as to provide an appropriate optical power for the wearer. In some embodiments, the sensing mechanism may be configured to receive an indication from a user to activate or deactivate the dynamic optic. Any suitable sensing mechanism may be used. For example, some embodiments may use one or more photosensors that detect changes in ambient illumination. Photosensors typically comprise silicon or SC photocells, and may be installed facing inwards (e.g. facing toward the wearer's eye) so that they can detect level of illumination inside the eye. In some embodiments, a motion sensor may be utilized that may, for example, pick-up (i.e. detect) motion (e.g. acceleration) of the wearer's eyeball and may thus be programmed to detect changes in gaze direction (the direction of the wearer's gaze may indicate whether they are viewing a near distance object or a far distance object). In some embodiments, a blink sensor may be used to detect the occurrence of a blink (or a series of blinks) that can be used to signal the need to turn “ON” or otherwise activate or tune the dynamic lens. The blink sensor may operate by, for example, using piezoelectric (e.g. compression of a material by the eye lid may create a voltage that may be detected) or photovoltaic (e.g. the eye lid may reduce the amount of light) detection principles. In some embodiments, a micro-gyroscope or micro-accelerometer may be used (e.g. a small, rapid shake or twist of the eyes or head may trigger the micro-gyroscope or micro-accelerometer). A range finder or similar device may also be used in some embodiments to determine the distance of an object that is being viewed. In general, any suitable sensing method may be used, as may be understood by a person of ordinary skill in the art after reading this disclosure.

In some embodiments, a device comprising a dynamic optic may include a controller that may control the function of the dynamic optic. For instance, some embodiments may utilize a logic controller, such as a hybrid ASIC, that manages the power budget, processes signals, and/or determines when the dynamic optic should be turned “ON” or tuned. The controller may also operate voltage amplifiers that may be required for operation of the dynamic optic and/or store data associated with the device, as needed. The controller may perform some or all of these functions, as well as related control and management functions.

As described above, embodiments may provide for a change in focal power of a dynamic optic (which may either be partially or fully enclosed within the self-contained module) located within an intraocular lens or contact lens. In some embodiments, a host contact lens may comprise a material that can be that of a soft lens, rigid lens, or a combination thereof. In some embodiments, the focal power of the intraocular or contact lens may be changed based on a dynamic optic disposed therein, that comprises, for example, any one of a: (1) Diffractive Optic; (2) Pixilated Optic; (3) Refractive Optic; (4) Tunable liquid crystal optic; (5) Shaped liquid crystal layer; (6) Shaped liquid layer (7) fluid lens (e.g. where the fluid may be compressed into the area of a central optic, thus causing the central optic (or a component thereof) to swell and/or to become more convex in curvature causing the optical power to increase in plus optical power); (8) Conformal fluid lens (e.g. where the fluid may be removed from the area of a central optic, thus allowing a covering member (e.g. a membrane) to take the shape of (i.e. conform to) a substrate beneath (or adjacent to the membrane) having a steeper convex curvature causing an increase in plus optical power). However, any suitable dynamic optic may be used.

As noted above, embodiments may provide for a power source that may be remotely charged (e.g. by way of inductive charging). Examples of such embodiments are shown and described with respect to FIGS. 1-3 below. For example, embodiments may have inductive coils for remote charging. In some embodiments, the intraocular lens may be charged after being removed from the eye and placed, for instance, in a contact lens case that serves as both a contact lens case and a charger. Such embodiments may allow for charging when the lenses are not in use, but may require that the lens be removed from the eye at some interval to charge (which may not be preferred for individuals that would like to keep the intraocular or contact lens in the eye for an extended period of time). In some embodiments, the intraocular or contact lens may be charged while being worn in the eye by, for instance, using eye glasses or an eye mask for sleeping that is capable of inductive charging of the intraocular or contacts lenses when being worn. Such embodiments provide the advantage of charging the lens without requiring the wearer to remove the lens from the eye and without the need to include additional charging components within lens (e.g. within the self-contained electronics module in some embodiments). In some embodiments, the intraocular or contact lens may itself comprise a charging module (such as a kinetic energy source that uses induction) to charge a power source (such as by having a magnetic material that moves through a conductive loop). This may provide some embodiments with the advantage that the dynamic lens may be continually charged without removal from the eye or the need for the wearer to use special devices to charge the device.

Some embodiments provided herein may comprise methods and components for determining when to change the optical power of the dynamic optic. For example, as shown in FIGS. 1-4, 7-10, and 12, embodiments may use one or more photo-detectors/diodes that can determine if the wearer's eyelid is closed (and for how long) and/or that may be capable of measuring the light reflected off of the retina of the eye. This may be used to indicate the direction of a gaze of a wearer and/or may be used by the wearer to signal the dynamic optic to change (e.g. through rapidly blinking, or a series of slow blinks, that may signal the dynamic optic to activate). Other sensors may also be used, such as those that detect movement of the eye ball or blinking of the eye lid. For example, a micro-gyroscope, micro-accelerometer, and/or a range finder may be utilized to detect when to activate the dynamic optic. These sensors are described in detail in U.S. Pat. No. 6,851,805, which is hereby incorporated by reference in its entirety. A controller (such as a micro ASIC) may also be housed within the lens (e.g. within a sealed self-contained electronics module in some embodiments) that may receive signals from the sensing mechanism and may then determine whether to activate the dynamic optic. The controller may also control the amount of current and voltage supplied to the dynamic optic (and any other components), and may control any other suitable components or perform related functions.

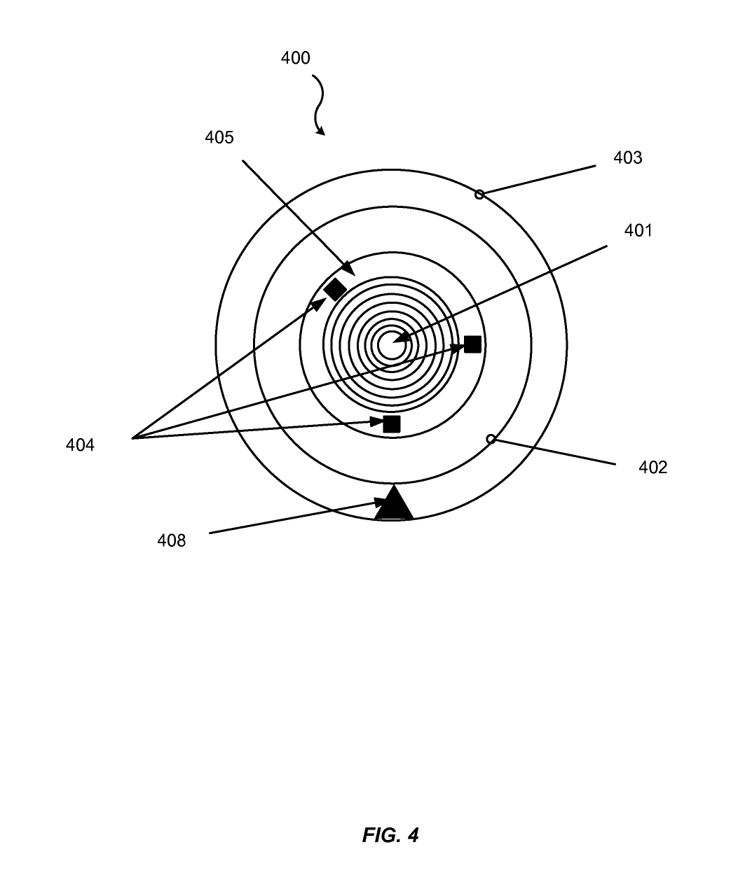

In some embodiments, the dynamic optic and/or a sealed self-contained electronics module that may contain the dynamic optic (and one or more electronic components) may be mostly stabilized from rotating upon a blink by the wearer by utilizing a stabilizing device or component, such as a prism weight (or similar component). An example of an embodiment comprising a prism weight is shown in FIG. 4 and described below. The prism weight may be fabricated by, for instance, thickening of the host material of the intraocular or contact lens near, or at, the lower perimeter of the host lens. This may be done, for instance, so as to properly orient the view detector/photo-detectors when they are configured to sense away from the eye (i.e. in the direction of the wearer's gaze) so that the view detector/photo-detector are positioned between the two eye lids (i.e. the upper and lower eye lids) and are not covered unless the eye lid blinks. However, embodiments are not so limited (e.g. in some embodiments, the photo-detectors may be pointed back towards the pupil of the eye and may measure the light reflected out of the eye). A stabilizing component (which may include, by way of example only, a thickening of the host lens material in a particular region that serves as a prism weight, truncation of the bottom of the host lens material, a battery (which may for instance provide electrical power and also serve as a stabilizing weight and can be located within a sealed self-contained electronics module near the bottom of periphery of the sealed self-contained electronics module) may be provided regardless of the orientation or type of sensing component used.

In some embodiments, a capacitor may be included that can be remotely charged and/or can maintain/store an appropriate charge to provide electrical power for the dynamic optic (e.g. while the intraocular or contact lens is in the wearer's eye). Examples of embodiments that comprise a capacitor as a power source are shown in FIGS. 1-4, 7, 9, and 12, and described below. In some embodiments, the intraocular or contact lens may be a “fail safe” device—that is, an increase in plus optical power that is used for near point focus may be provided only when the electrical power is turned “ON.” When the electrical power is turned “OFF,” there may be little or no electrical power drain. This may be the case whether a fail safe device comprises a battery, capacitor, micro nanowires, or any other means to store and/or maintain an electrical charge. When the electrical power to the dynamic optic is turned “OFF,” the intraocular or contact lens may be configured to provide a distance vision optical power for the wearer. That is, when the dynamic optic (which may be located—e.g. disposed—completely or partially within a sealed self-contained module) provides no optical power, the intraocular or contact lens may provide a required optical power for a wearer to view distant objects (which may, in some instances be no optical power or a negative optical power). The distance optical power may, for instance, be provided by a static lens or a surface of the contact lens matrix that is included in the intraocular or contact lens (and which may be in optical communication with the dynamic optic or a portion thereof). When the electrical power to the dynamic optic is turned “ON,” (i.e. current or voltage is supplied to the dynamic lens) the intraocular or contact lens (or a portion thereof) may provide the near vision optical power for the wearer (e.g. the dynamic optic that may be located completely or partially within a sealed self-contained electronics module may provide some or all of the plus optical power needed by the wearer). This optical power may be combined with any optical power provided by one or more other optical components of the device (such as the components of the host lens) that are in optical communication with the dynamic optic, such as an aspheric add zone created by a structure disposed on the surface of a substrate of the host lens.

In some embodiments, a device such as a contact or intraocular lens may further comprise an electronic component such as an electromagnet that may be used to alter or change the optical power provided by the dynamic optic. For example, the host lens (and/or a self-contained electronic module disposed within a host lens in some embodiments) or the dynamic optic itself may comprise or contain an electromagnet that, when voltage or current is supplied thereto, exerts a force on a portion of the dynamic lens. In some embodiments that comprise a fluid lens, the electromagnet may be used to move the fluid into, or out of, an area of the dynamic optic. Exemplary embodiments that use an electromagnet are shown in FIGS. 9 and 10 and described below. Exemplary embodiments may, for example, comprise (1) an electromagnet having two components such that when current or voltage is applied, a force is created between the two components; (2) two separate electromagnets that may each be supplied current or voltage independently, but that when both are energized, a force is created between them; or (3) an electromagnet and one or more magnetic materials such that, when current or voltage is supplied to the electromagnet, a force is created between the electromagnet and the magnetic material. However, embodiments are no so limited, and any suitable configuration may be utilized. As was described above, an electromagnet may be constructed and disposed in any suitable manner, including by depositing a layer of an electromagnetic material on one or more surfaces or components of the intraocular or contact lens.

Continuing with exemplary embodiments that comprise an electromagnet, for some embodiments where the dynamic lens comprises a fluid lens that utilizes a membrane (e.g. a bladder) that may contains some or all of the fluid of the lens, and for which the optical add power provided by the dynamic lens may be based on the shape of a flexible element and/or the location of the fluid, the electromagnet may be formed by, for example, depositing a coating of electromagnetic material on the opposing surfaces of the membrane (e.g. the front and back membrane surfaces). Such deposition can be on the external surfaces of the front and back membranes, the internal surfaces of the front and back membranes, or both the internal and external surfaces of the front and back membranes (although in some embodiments it may be more efficient to deposit the layer on the outer surfaces of the membrane, which may also make formation of the electrical contacts between the power source and the electromagnetic material more readily achievable); however, embodiments are not so limited. For instance, in some embodiments that comprise a membrane that is affixed to a non-membrane substrate member, the deposition coating of the electromagnetic material may be such that it is deposited on the surface of the membrane and also the surface of the non-membrane substrate member. The deposition coating may be such that when an electrical current or voltage is applied to the deposition coating on one surface of the membrane (e.g. the front coating) and to the deposition coating on the opposing side or surface of the membrane (e.g. the back coating)- or on the surface of fixed substrate member—a magnetic attraction occurs pulling the two coatings towards each other. For example, the two surfaces of the membrane may be pulled together by the generated magnetic force, thereby creating a force between the two surfaces. When the electrical current is removed, the two deposition coatings may no longer create a magnetic attraction, and thereby the two deposition layers may move away from each other (or simply return to a relaxed state).

As noted above, the movement of the two deposition coatings towards one another may, in some embodiments, act to move the fluid disposed between the membrane surfaces (or between the membrane surface and the fixed substrate surface) towards the center of a dynamic optic comprising a liquid lens. This may cause an increase in the steepening of the convex curvature of a flexible element of the fluid lens, which may then increase the plus optical add power of the dynamic optic (as shown in the exemplary embodiments in FIGS. 9 and 10). As noted above, the exemplary dynamic optic comprising a fluid lens may be located partially or fully within a sealed self-contained electronics module; however, embodiments are not so limited. The movement of the two deposition coatings of the electromagnet material away from one another (e.g. when voltage or current is not applied) may result in the fluid moving away from the center of the dynamic optic comprising a fluid lens, thereby causing a decrease in the steepening of the convex curvature of the flexible element, which may then decrease the plus optical power of the dynamic lens. In some embodiments, the contact lens in this relaxed state may be configured to provide distance optical power for the wearer.

In some embodiments, an electromagnet may be disposed so as to apply force to a membrane that functions similar to a membrane reservoir for holding fluid (which may be referred to herein as an example of a “fluid holding element”). The fluid holding element may be disposed adjacent to (or be configured to apply fluid to a region that is adjacent to) a portion of the dynamic optic that comprises a flexible element that may provide the dynamic optical power (e.g. by changing its shape or radius of curvature). An example of such embodiments is shown in FIG. 9 and described below. The electromagnet(s) may apply a force (or not apply force) to the membrane reservoir (e.g. an electronic controlled bladder) so as to apply fluid to (or receive fluid from) the region of the dynamic optic adjacent to the flexible element (e.g. the fluid may be applied from the membrane reservoir to a fluid cavity disposed in a central optic region—thereby changing the radius of curvature of the adjacent flexible element). However, embodiments are not so limited. For example, in some embodiments, the fluid cavity and the membrane reservoir (e.g. bladder) may be the same—that is, the fluid may be contained within a membrane reservoir (or in a fluid cavity between a substrate and a membrane) that is disposed in the central optic region of the dynamic optic (e.g. the region where the plus optical power may be provided by the dynamic lens). An example of such an embodiment is shown in FIG. 10 and described below. The electromagnet(s) may be disposed around the peripheral edge (or a portion thereof) of the membrane reservoir that holds the fluid. When a current or voltage is applied to the electromagnet, a force may be applied to the peripheral edge of the membrane, thereby forcing the fluid disposed along the edge to the center of the fluid cavity. This increase in fluid in the center of the membrane reservoir may cause the central portion of the membrane to expand (i.e. to increase its radius of curvature) and thereby provide additional plus optical power to the dynamic optic.

Although generally described above with respect to embodiments of a fluid lens that comprise a flexible element that may add plus optical power when the radius of curvature of the flexible element is increased (e.g. when additional fluid is applied to a region adjacent to a flexible element of the dynamic fluid lens), embodiments are not so limited. For instance, some embodiments may comprise a conformal electrically controlled fluid lens that may provide additional plus optical power when fluid is removed from the region adjacent to the flexible element (e.g. when fluid is removed from the cavity between the flexible element and a substrate, the flexible element may conform to a substrate having a surface geometry that provides additional plus optical power). In some embodiments, the fluid may have a refractive index such that the fluid lens may not require a flexible element to change shape to provide dynamic optical power, but may provide a dynamic optical power based on the amount of fluid that fills a fluid cavity in a region of the dynamic optic (e.g. the index of refraction of the fluid may be index mismatched with a substrate or other component of the contact lens such that light may be refracted at the interface of the two regions). In some embodiments, the fluid may be indexed matched with a substrate, where the substrate may comprise a surface structure (such as a diffractive structure) that is effectively hidden (i.e. it does not provide optical power) when the index matched fluid substantially covers the surface, but when the fluid is removed from the region, the substrate may provide optical power to the dynamic lens. It should be understood that any type of dynamic fluid lens may be used, and that the above are provided as examples only.

As noted above, one or more electromagnet(s) that may be utilized in some embodiments. The electromagnets may be fabricated in any suitable way, including by way of depositing thin layers of a ferromagnetic on a plastic or glass film that may be magnetized upon application of an electric field. Some example materials that may be used for the layers of the electromagnet may include:

Mn doped ZnO layers that were investigated by Sharm, et al. as reported in Nature materials, 2, 2003: pp 673-677, which is hereby incorporated by reference in its entirety;
YIG (Yttrium Iron Garnet) layers as disclosed in U.S. Pat. No. 4,887,052, which is hereby incorporated by reference in its entirety; and
La_{0.3}A_{0.7}Mn0₃, where A may be Ba²⁺, Ca²⁺, or Sr²⁺, as reported by Hundley et al. in J. Appl. Phys. 79(8), 1996: pp 4535, which is hereby incorporated by reference in its entirety.

In this regard, the inventors have found that in some embodiments, it may be preferred that the thickness of the layers of the ferromagnetic material may be within the range of approximately 2-3 microns. This may generally provide a strong enough magnetic field when activated by a reasonable current or voltage in most embodiments so as to apply a force sufficient to drive a dynamic optic from a first to a second optical add power (e.g. by moving fluid to portions of an exemplary fluid lens), while maintaining a relatively small form factor (which as noted above, may be a consideration in choosing components for the dynamic optic or other components of an intraocular or contact lens). However, any suitable material and thickness may be used for the layers of the electromagnet depending on the application of the device, as well as other practical considerations including by way of example: the type of dynamic optic utilized; the power source used; the space available in the self-contained electronics module; the type of ferromagnetic material used, etc.

In some embodiments, the ferromagnetic layer may then be over-coated with a transparent (or semi-transparent) layer of a conductor such as ITO to form the electrical connection with a power source. It is generally preferred that the conductor be transparent or semi-transparent because in most embodiments, an opaque structure or component may be visible within the intraocular or contact lens, and may thereby distract the wearer. The inventors have found that for most embodiments, a thickness of ITO within the range of approximate 100-200 nm may be sufficient (although any suitable conductive material and thickness may be used, with the general understanding that the thicker the conductive layer the less resistivity losses may result from sheet resistance). When an electric voltage or current is applied to the ferromagnetic layer, the ferromagnetic layer develops magnetism, and attracts (or repels) a similar layer of a ferromagnetic coating (or other magnetic material) on an adjacent film (depending on the polarity of each coating layer). In this manner, a force may be selectively applied between two or more layers of the ferromagnetic material. In some embodiments, an over layer may be applied to seal the magnetic material layers so as to protect and/or insulate the electronics and isolate them from a dynamic lens (such as a fluid lens). In some embodiments, this thin over layer can be made of, by way of example only, Si0₂ and may be deposition coated.

In general, an intraocular or contact lens may comprise one dynamic optic, or two or more dynamic optics stacked (or otherwise disposed) such that the dynamic optics may be in optical communication with one another. As noted above, the optical power provided by the dynamic optic may be that of a switched optical power (i.e. going from one optical power to another optical power) or can be continuously tunable from one power to another, by way of example only, a fluid lens (e.g. by continuously varying the fluid in a region so as to change the curvature of a membrane) or a pixilated refractive optic.

In some embodiments, if the host lens materials provide optical power then the optical power of the contact lens may be the combined optical power of the dynamic optic and that of the host lens material (e.g. when the dynamic optic is activated). In some embodiments, where the host lens may not provide optical power, then the optical power of the contact lens may be provided solely based on the optical power provided by the dynamic optic. In some embodiments, the host lens may provide the distance vision corrective optical power for the wearer and the dynamic optic may provide the intermediate and/or near optical add power for the wearer (indeed, this is generally preferred as the use of a dynamic optic provides the efficiency of utilizing a single intraocular lens that may be used for viewing objects at different distances). In some embodiments, additional depth of focus may be provided by the host lens (or other optical components disposed therein). In such embodiments, the host lens may include a very small diameter central aspheric region.

In some embodiments, an intraocular or contact lens may provide the majority of the focus on the retina of the wearer's eye upon the change of optical power of the dynamic optic. Thus, unlike present static (i.e. not dynamic) multifocal intraocular or contact lenses, embodiments provided herein may focus most, if not all, light on the retina at anyone time. This is in contrast to present static multifocal intraocular or contact lenses that split the light so that a first image is focused on the retina and a second image is not focused on the retina, which may therefore require the brain of the wearer to chose which image to focus on. As noted above, embodiments may comprise an intraocular or contact lens that provides only one focus and thus the brain of the wearer need only choose what image is on the retina for visual input. In addition, the use of an electrically controlled dynamic optic may provide increased reliability and better performance than intraocular lenses that may, for instance, rely on the force of the wearer's eye muscles to change the shape of the lens. For example, electrically controlled dynamic lenses may receive signals from the user, or monitor one or more different stimulus to determine if and when to activate a dynamic optic.

Although embodiments provided herein are generally described in relation to contact and intraocular lenses, some of the features, components, and methods disclosed may have applicability to other fields and devices. For instance, some aspects of devices described herein may be utilized in other optical lenses such as those that are included in eyeglasses (e.g. spectacles), and even large scale optical systems that may utilize one or more dynamic lenses. Indeed, it is generally desirable in many optical systems to reduce the size of components and features (particularly those that may control or change the optical add power of a device). Thus, many of the components and features discovered by the inventors to be particularly applicable to intraocular and contact lens embodiments where the available space may be minimal, may also be utilized in these other applications. By way of example only, the use of electromagnets and/or electronic controlled bladders to drive the dynamic optic between one or more optical add powers may have applicability to a dynamic lens in any system. Thus, while the exemplary embodiments shown in FIGS. 9 and 10 are shown as a contact lens or intraocular lens embodiment, this should not be understood to be limiting. Similarly, the features discovered by the inventors to have particular applicability in power generation in the relative confines of many intraocular and contact lenses (such as the use of micro nonowires), may also have applicability in other dynamic optic embodiments. Thus, in general, some of the aspects and features of each of the exemplary embodiments described below may have applications in other optical fields and devices.

### Exemplary Embodiments

Described below are exemplary embodiments of devices (and methods of manufacturing devices) comprising a dynamic optic, such as a contact lent or intraocular lens. The embodiments described herein are for illustration purposes only and are not thereby intended to be limiting. After reading this disclosure, it may be apparent to a person of ordinary skill that various components and/or features as described below may be combined or omitted in certain embodiments, while still practicing the principles described herein.

In some embodiments, a first method may be provided. The first method may include the steps of providing a dynamic optic and disposing the dynamic optic into a first lens, where the first lens is anyone of a contact lens or an intraocular lens, and where the dynamic optic may comprise a fluid lens. The first method may further include the step of providing an electronic component and disposing the electronic component into the first lens. As used herein, “providing” may comprise any suitable manner of obtaining a dynamic optic or electronic component, such as for instance: fabricating some or all of the components of the dynamic optic or electronic component; receiving, purchasing, or otherwise obtaining some or all of the parts from a third party and assembling the dynamic optic or electronic component; receiving, purchasing or otherwise obtaining the dynamic optic or electronic component from a third party, etc. The dynamic lens and/or electronic component may be disposed in the first lens in any suitable manner. For example, the dynamic optic or electronic component may be inserted into an opening of the host lens material, and the host lens may then be sealed around the dynamic optic or electronic component, or the host lens may be manufactured around the dynamic optic and/or electronic component.

Currently, electrically controlled fluid lenses are not provided for use in optical devices that are to be used in contact or intraocular lenses because, for instance, these lenses may generally comprise components and materials that are relatively large, they may be complex (e.g. the fluid lens may comprise mechanical parts such as pumps or actuators to move fluids throughout the device), they may be difficult to manufacture (particularly on a small scale), and/or these lenses may be susceptible to failure and leakage of materials. However, the inventors have found that through various methods, apparatus, and devices (and combinations thereof) disclosed herein, it may be possible to utilize some or all of the advantages of dynamic fluid lenses in a contact or intraocular lens. For example, through the use of electrical components such as electromagnets, the inventors have found in some embodiments that fluid may be controlled within a fluid lens without the use of mechanical parts. Moreover, electromagnets, as explained above, may comprise a thin layer of materials that may be deposited onto components or surfaces of the device, which may generally be performed on a relatively small scale with precision. In addition, the inventors have found that small materials such as micro nanotubes may be used to generate, store and/or transfer electric charge between components. In some embodiments, the use of a self-contained electronics module may both decrease the probability that components of the fluid lens (e.g. the fluid) may leak out of the host lens and may also protect and/or insulate the electronic components of the dynamic optic from damage or shorts. However, in general the embodiments disclosed herein are not limited the use of these specific components such as electromagnets. The inventors have developed intraocular and contact lenses that may, in some embodiments, comprise a fluid lens that may be driven by one or more electronic components and may thereby provide a dynamic optical power for a wearer, while also potentially remaining comfortable for use and accurately and reliably providing a desired optical power.

In some embodiments, in the first method as described above that includes the steps of providing an electronic component and a dynamic optic that may comprise a fluid lens, the electronic component may be configured to drive the dynamic optic between a first optical power and a second optical power. As used herein, “drive” the dynamic may refer generally to any method or manner of activating the lens, or otherwise causing the dynamic fluid lens to change the optical power provided. For instance, it may comprise the electronic component supply electrical power to the fluid lens or a component thereof, applying a physical or mechanical force to the dynamic lens, applying a magnetic force, increasing fluid pressure, etc. For example, in some embodiments, the electronic component may drive the dynamic optic by applying a force on a flexible element of the dynamic optic (e.g. an electromagnet may apply a magnetic force to a magnet that is coupled to a flexible membrane). In some embodiments, the electronic component may drive the dynamic optic by applying a force to a liquid such that the fluid exerts a force on a flexible element of the dynamic optic.

In some embodiments, in the first method as described above, the electronic component may include an electromagnet. As noted above, the electromagnet(s) may be disposed in any suitable location so as to provide a magnetic force when current or voltage is provided. The force may be applied directly to a component (e.g. by applying force directly to a flexible membrane or a component that may move in a dynamic lens), or it may be applied indirectly (e.g. in a fluid lens, the force may be applied to a fluid holding element so that the fluid may exert (or does not exert) a force or pressure on a flexible element) to change the optical power of the dynamic lens. In some embodiments, in the first method as described above, the electronic component may comprise an electronic controlled bladder. In some embodiments, in the first method as described above, the first lens may include one or more micro nanowires. As described above, micro nanowires may provide some embodiments with the advantage of generating electrical charge in a relatively small area, thereby facilitating the use of electronic components in contact lens or intraocular lens embodiments.

In some embodiments, in the first method as described above that includes the steps of providing an electronic component and a dynamic optic, where the dynamic optic may comprise a fluid lens, and disposing the electronic component and the dynamic optic into anyone of a contact lens or an intraocular lens, the first method may further include the steps of disposing the dynamic optic into an electronics module and sealing the electronics module so as to form a self-contained electronics module. As used herein, “sealing” the electronics module may refer to when the components are contained within the electronics module such that they may not be removed without altering the structure of the module or components thereof. For instance, sealing may refer to when an opening of the electronics module where components were inserted into the module is closed. Sealing may comprise coupling two components of the housing module together (e.g. two sheets of material that may also form a side or wall of the module), or inserting a new component between two or more components of the electronics module housing so as to close an opening. As used herein, module “housing” may refer to any component that may hold, contain, and/or surround the electronic components and the dynamic optic. The housing may comprise any suitable material, including glass or plastic. The module itself may have an opening for inserting a component into the module, or the module may be formed around the component—including the dynamic optic. In some embodiments, the components within the module may still interact with components outside of the module, such as through one or more electrical conductors. For instance, in some embodiments, a power source may be located within the self-contained electronics module, but different elements of a charging module may be located outside the module that may then transmit current or voltage to the power source disposed within the module. In some embodiments, an electrical signal may be passed from an external component to the components within the electronics module, such as to control or override the dynamic optics. However, it may be preferred in some embodiments that there are no connections to the components in the electronics module to outside components. This may, for instance, decrease the complexity of manufacturing (i.e. there may be no need to make electrical connections when disposing the electronics module into a contact lens matrix) and/or provide for electrical insulation to the electrical components therein.

The electronics module may be sealed in any suitable manner. For instance, in some embodiments, sealing the electronics module may include any one of: heat sealing, laser welding, ultrasonic welding, or the use of an adhesive bond. In general, it may be desirable that the seal be as permanent as possible, as this may prevent any materials from the dynamic optic (or any of the other electronic components) from leaking out of (or otherwise being released from) the self-contained electronics module and potentially into a wearer's eye (although as noted above in some embodiments, there may be one or more components located inside the sealed electronics module that interact with one or more components on the outside).

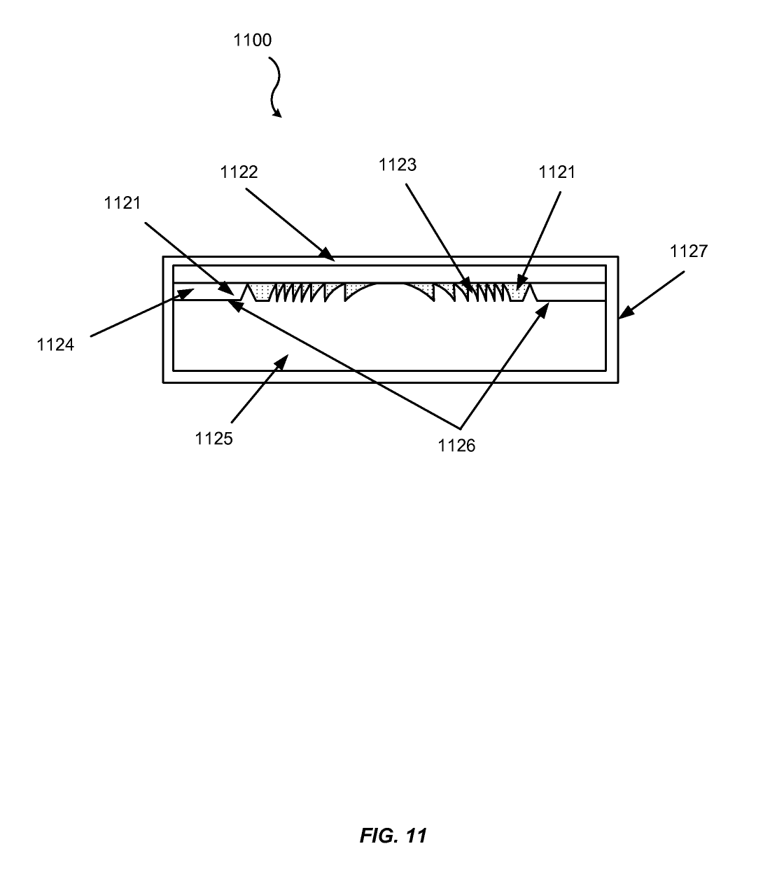

The “self contained electronics module,” as was defined above, may refer to a module that comprises some or all of the components that may be utilized to provide dynamic optical power. The components that may comprise the electronics module (such as, for example, a power source, sensor, and/or controller) may, in some embodiments, be manufactured in any suitable manner and may be permanently or removably coupled to the electronics module. An exemplary method of manufacturing a device is described below with reference to FIG. 11.

In some embodiments, the step of disposing the dynamic optic into the first lens in the first method as described above may comprise disposing the self-contained electronics module into the intraocular lens or the contact lens. That is, for instance, in some embodiments that may include a self-contained electronics module, the dynamic optic may be disposed (e.g. contained within) the self-contained module. The dynamic optic may first be disposed within the electronics module (which may then be sealed) and then the module may be disposed within the host lens (e.g. the contact lens or intraocular lens). This may reduce manufacturing complexity because, for example, the components may be fabricated and assembled separately.

In some embodiments, the self-contained electronics module may contain the electronic component. That is, for instance, in some embodiments, the electronics module may include any one of, or some combination of: an electromagnet; an electronic controlled bladder; one or more micro nanowires; a kinetic energy source; and/or a capacitor. In general, the electronics module may comprise any suitable component. However, as noted above, for embodiments that may be utilized in a contact lens or intraocular lens, the inventors have found that it may be preferred to use components that may reduce the size of the electronics module (and thereby potentially decrease the size of the host lens). For example, the use of electromagnets (particularly with fluid lenses, where it may be combined with an electronic controlled bladder) may reduce the size needed over traditional mechanical components such as pumps to apply fluid; the use of micro nanowires may reduce the size of a kinetic energy source or other electrical devices and connections; a kinetic energy source may reduce the size of an energy storage element (because less charge may need to be stored, as it may be generated when needed); and a capacitor may be used so that a large (and potentially more expensive) battery need not be included. Each of the above is provided by way of example only, and some, all, or none of these components may be included in some embodiments.

Embodiments of the method described above that comprise a self-contained electronics module may provide some advantages. For instance, by inserting a sealed self-contained electronics module into an intraocular or contact lens such as a contacts lens matrix (rather than manufacturing the components together—e.g. such as when the dynamic lens comprises a part of the intraocular or contact lens), embodiments may provide for a more cost effective manufacturing process. Each component may be produced separately and in large volume, and may only later be combined as needed. Moreover, some embodiments may allow for different self-contained electronics module to be used with a variety of contact lens matrixes to better meet consumer preferences. That is, for instance, rather then having to custom produce each host lens for each wearer, a consumer may select the proper electronics module (i.e. one that comprises the correct dynamic lens for providing a needed add power for the wearer), which may then be combined with a separate host lens that provides the proper far distance optical power needed by the user. The two components may be combined and then provided to the consumer for use. This may significantly reduce fabrication costs and time, and may provide consumers with more options regarding the intraocular lens they are ultimately provided.

In some embodiments, in the first method as described above that includes the step of disposing a dynamic optic into an electronics module and sealing the electronic module, the step of disposing the self-contained electronics module into the first lens may comprise disposing the self-contained electronics module into a contact lens matrix. As used in this context, “disposing” may comprise any manner that results in the self-contained module being located in a contact lens matrix, including by way of example: inserting the self-contained module into a cavity or an opening in the contact lens matrix, forming the contact lens matrix around the module, etc.

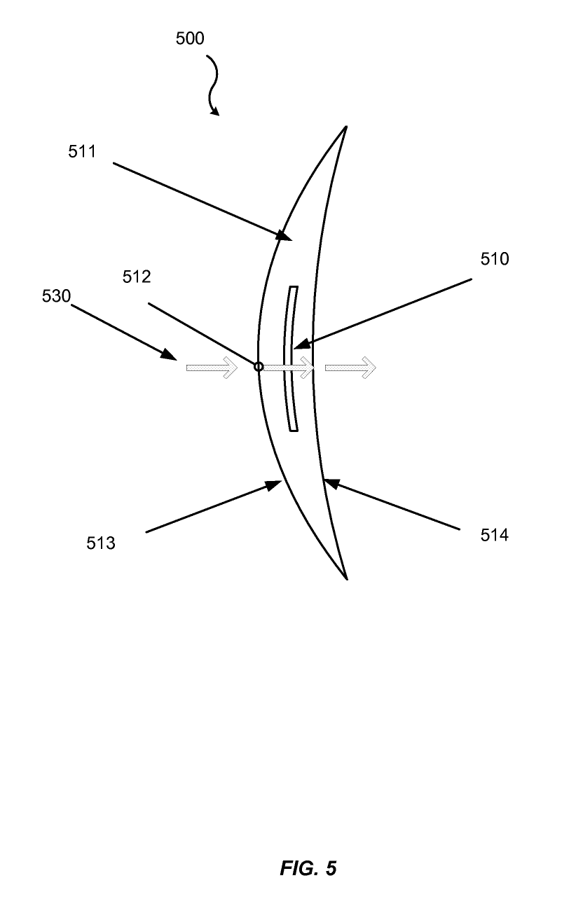

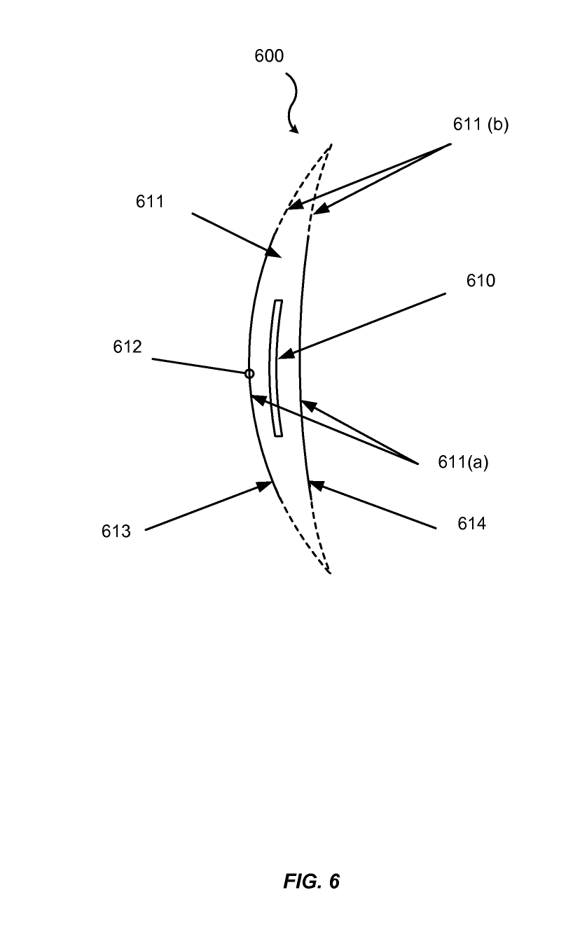

In some embodiments, the contact lens matrix may comprise a soft lens, a hard lens, or a combination thereof. Example embodiments are provided below with reference to FIGS. 5 and 6 (where FIG. 6 discusses a combination of hard and soft materials). As noted above, in some embodiments, the method described above may allow a wearer to readily customize a contact lens (or an intraocular lens) by selecting different components that they would like to include (e.g. different optical add powers, etc.). This may also be true for other factors such as a wearer's preference with regard to the material or type of contact lens or intraocular lens that is utilized. Other factors that a consumer may be permitted to choose may also be related to, for instance, the suitable duration of the lens (e.g. if the host lens is to be disposable or worn for an extended period of time, which may effect the power source, recharging module, etc.), the price of the device, etc.

In some embodiments, in the first method as described above that includes the steps of disposing a dynamic optic into an electronics module and sealing the electronics module, the self-contained electronics module may contain a power supply; a controller; and/or a sensing mechanism, and the dynamic optic may be configured to provide a first optical power and a second optical power. As noted above, it may be generally preferred (but may not be required) that the self-contained electronics module may include all of the components so that it may function as a stand alone device that provides dynamic optical power. For such embodiments, the self-contained electronics module may include a power source (to power the dynamic optic and/or the other electronics), a sensing module (to determine when to activate or tone the dynamic optic, such as based on a wearer's signal;—e.g. blinking—or based on the gaze of the user—e.g. automatically); and a controller (which may receive input from the sensing module and determine whether to activate or deactivate the dynamic optic). However, embodiments are not so limited, and one or more of these components may in some embodiments be disposed outside the self-contained electronics module and be coupled to one or more of the components. In general, the components may be disposed within the electronics module in any suitable manner, including by being inserted into an opening or having the electronics module housing disposed (e.g. fabricated) around each of the components.

In some embodiments, the self-contained electronics module may comprise at least one of a plastic or a glass. The inventors have found that glass and plastic may include materials that are (1) biocompatible (although the electronics module in some embodiments may not directly contact the wearer's eye, there is a possibility that the lens matrix may be damaged); (2) transparent or semi-transparent; and/or (3) that may have a small form factor while providing adequate containment of the dynamic optic and/or the other electronic components, etc. In some embodiments, the self-contained electronics module may include one or more glass sheets, where the one or more glass sheets may have a thickness that is between approximately 10 and 200 microns. As noted above, in some embodiments (particular those that may involve utilizing the self-contained electronics module in an intraocular or contact lens), the form factor and thereby the relative size of each of the components may preferentially be minimized, while still providing enough strength to adequately contain the electronics and the dynamic lens. Thus, the inventors have found that, in general glass sheets as thin as 10 microns may be strong enough to adequately manage the stress associated with being located in a wearer's eye, while glass sheets as large as 200 microns may still be thin enough to provide for adequate space for other components without obstructing the user's experience. Preferably, the one or more glass sheets may have a thickness that is between approximately 25 and 50 microns. In some embodiments, the one or more glass sheets may have a refractive index that is between approximately 1.45 and 1.75. In general, it may be preferred that the material that comprises the self-contained electronics module have an index of refraction that approximately matches the other optical components so that there is not an unintended refractive surface within the device that was not accounted for (and that may be noticeable to a wearer). Typically, the refractive index of liquid crystal and/or other common components of an optical system may be within the above range. However, the closer to matching the index of refractions, the less noticeable the deviation may be to the user, and therefore it may be preferable that the one or more glass sheets may have a refractive index that is between approximately 1.50 and 1.70. An exemplary material that the inventors have found effective includes In some embodiments, one or more glass sheets may comprise commercially available Borofloat glass.

In some embodiments, in the first method as described above that includes the steps of disposing a dynamic optic into an electronics module and sealing the electronics module, the self-contained electronics module may comprise one or more plastic sheets. In some embodiments, the one or more plastic sheets may have a thickness that is between approximately and 200 microns. The inventors have found that plastics may generally comprise smaller thicknesses than some glass materials, but may still provide adequate containment of the components therein. This may reduce the size of the electronics module, and thereby allow for more electronics or reduced the overall size of the intraocular or contact lens. Thus, in this regard, it may be preferred that the one or more plastic sheets may have a thickness that is between approximately 7 and 25 microns. In some embodiments, the one or more plastic sheets may comprise polyfluorocarbons. In some embodiments, the one or more plastic sheets may comprise PVDF or Tedlar, which are examples of materials that have been found to have sufficient properties to be used in such devices. However, embodiments are not so limited, and any suitable material may be used.

In some embodiments, in the first method as described above that includes the steps of providing an electronics module that includes a dynamic optic and sealing the electronics module, where the dynamic optic comprises a fluid lens, the fluid lenses may comprise a structure similar to the exemplary embodiments shown in FIGS. 9 and 10. As noted above, such embodiments may be preferred because they may comprise materials that are small, robust, and/or relatively inexpensive, particularly in comparison to current fluid lens components and some dynamic optics that comprise an electro-active cell (e.g. that utilize one or more liquid crystals). Moreover, by fabricating the fluid lens in a separate process, and integrating the dynamic lens into the other components, embodiments may be less complex in manufacturing. However, embodiments are not so limited, and any suitable dynamic optic may be used.

In some embodiments, a first method may be provided that may include the step of providing an electronics module that contains an electronic component and a dynamic optic. The electronics module may have a thickness that is less than approximately 125 microns. The first method may further include the step of sealing the electronics module so as to form a self-contained electronics module. As was noted above, the inventors have found that, while contact lenses and intraocular lens may have any suitable thickness, it has generally been found that it may be preferred to reduce the thickness of such host lenses as much as possible. In this regard, the inventors have found that for embodiments of devices that comprise an electronics module, if the thickness of the of the module is maintained at less than 125 microns, it may typically provide enough remaining space so that a contact lens or intraocular lens nay include a dynamic optic, while not being uncomfortable or noticeable to a wearer. Thus, in this regard, in some embodiments, the electronics module may have a thickness that is less than 90 microns. In some embodiments, the electronics module may have a thickness that is less than 60 microns. As was described in detail above, the inventors have found that by utilizing components that may reduce the size of the dynamic optic, the electronics module, and of the host lens, an intraocular or contact lens may be provided that has at least one optical power region that may have a variable optical power. In some embodiments, the electronic component may comprise any one of, or some combination of, an electromagnet or an electronically controlled bladder. In some embodiments, the first method may further include the step of disposing the dynamic optic into anyone of: a contact lens or an intraocular lens.

In some embodiments, in the first method as described above that includes that steps of providing an electronics module having a thickness that is less than approximately 125 microns that that contains an electronic component and a dynamic optic, the dynamic optic may be discretely switchable between a first optical power and a second optical power. For instance, the dynamic optic may be “activated” or “deactivated.” In some embodiments, the dynamic optic may be continuously tunable between a first optical power and a second optical power. This may provide a wearer with the ability to adjust the optical power provided by the dynamic optic. As was described above, any suitable dynamic optic may be used, including by way of example, a fluid lens or an electro-active cell.

In some embodiments, a first device may be provided. The first device may include a first lens that comprises a contact lens or an intraocular lens. The first lens may include an electronic component and a dynamic optic, where the dynamic optic is configured to provide a first optical add power and a second optical add power, and where the first and the second optical add powers are different. The dynamic optic may comprise a fluid lens.

As was explained in detail above, in some embodiments the dynamic optic may provide more than two optical add powers and/or may be tunable or discretely switchable between two optical add powers. Moreover, the optical add power provided by the dynamic optic may be provided in only a region or portion of the device (e.g. a portion of the intraocular lens). Although some embodiments herein may be described for illustrations purposes as having the dynamic optic located in the center of an intraocular lens, embodiments are not so limited. That is, for instance, the dynamic optic may provide optical add power in any suitable location (although in some embodiments, such as contact lenses, it may be preferred that the dynamic optical be disposed substantially in the center of the device because typically the wearer tends to look through the center of the contact lens regardless of the distance, of the object being viewed.

In some embodiments, in the first device as described above that includes a first lens having an electronic component and a dynamic optic that may comprise a fluid lens, the electronic component may be configured to drive the dynamic optic between the first optical power and the second optical power. As noted above, the electronic component may drive the dynamic optic in any suitable way so as to change the optical add power of the dynamic optic, or a portion thereof. For example, in some embodiments, the electronic component may drive the dynamic optic by applying a force on a flexible element of the dynamic optic. In some embodiments, the electronic component may drive the dynamic optic by applying a force to a fluid such that the fluid exerts a force on a flexible element of the dynamic optic. Example embodiments of an electronic component (e.g. an electromagnet) driving a dynamic optic (e.g. a fluid lens) in this exemplary manner are shown in FIGS. 9 and 10 and described in detail below.

In this regard, in some embodiments, in the first device as described above that includes a first lens comprising a contact lens or an intraocular lens, an electronic component, and a dynamic optic that may include a fluid lens, the electronic component may comprise an electromagnet. In some embodiments, the electronic component may comprise an electronic controlled bladder. In some embodiments, the first lens may include any one of, or some combination of: of: micro nanotubes, a kinetic energy source, or a capacitor.

In some embodiments, in the first device as described above that includes a first lens comprising a contact lens or an intraocular lens, an electronic component, and a dynamic optic that may include a fluid lens, the first device may further comprise a self-contained electronics module. As noted above, an electronics module may be utilized to provide advantages, such as insulating and/or protecting the dynamic optic and electronic components and decreasing manufacturing complexity. In this regard, the self-contained electronics module may contain the dynamic optic (or a portion thereof) and/or the electronic component.

In some embodiments, in the first device as described above that includes a first lens and a self-contained electronics module that contains a dynamic optic configured to provide at least a first optical power and a second optical power, the self-contained electronics module may further include any one of, or some combination of: a power supply; a controller; and a sensing mechanism. As was noted above, it may be generally preferred (but may not be required) that the self-contained electronics module may contains some or all of the components so that it may function as a stand alone device that provides dynamic optical power. This may be advantageous, for instance, because it allows for the electronics module to be readily inserted into an intraocular lens, without the need for making any additional connections or integrating other components. For such embodiments, the self-contained electronics module may contain a power source (to power the dynamic optic and/or the other electronics), a sensing module (to determine when to activate or tone the dynamic optic, such as based on a wearer's signal; —e.g. blinking—or based on the gaze of the user—e.g. automatically); and/or a controller (which may receive input from the sensing module and determine whether to activate or deactivate the dynamic optic). However, embodiments are not so limited, and one or more of these components may, in some embodiments, be disposed outside the self-contained electronics module and be coupled to one or more of the components (or be omitted from the device). In general, the electronic components may be disposed within the electronics module in any suitable manner, including by being inserted into an opening or having the electronics module housing disposed (e.g. fabricated) around each of the components.

In some embodiments, in the first device as described above that includes a first lens and a self-contained electronics module that contains an electronic component and a dynamic optic configured to provide at least a first optical power and a second optical power, the first device may further include a contact lens matrix. In some embodiments, the self-contained electronics module may be disposed within the contact lens matrix. As used herein, “disposed within” may refer to when the self-contained electronics module may have a portion of the contact lens matrix disposed over each of its sides. That is, for instance, the contact lens matrix may surround the self-contained electronics module. Examples of this are illustrated in FIGS. 5 and 6. In some embodiments, it may be preferred that the electronics module may not be accessible “but through” a portion of the contact lens matrix. This may reduce manufacturing costs and complexity (e.g. the self-contained module may be “dropped into” the contact lens matrix, or the contact lens matrix may be formed around the entire module or portions thereof); this may permit for the use of a wide variety of materials for the module housing because, for instance, the electronics module may not readily contact a human eye (e.g. the contact lens matrix may comprise a more bio-compatible material so as to protect the eye and reduce irritation when used, while the electronics module housing may comprise a material that may be less bio-compatible, but may have other features—such as stronger material, less conductive, etc. that may be better suited for containing the electronic components and dynamic optic), etc. However, embodiments are not so limited, and in some instances, the self-contained electronics module may be disposed within the contact lens matrix, but there may be one or more portions that are, for instance, accessible to components within the contact lens matrix or to components outside of the contact lens matrix. For example, in some embodiments, there may be one or more conductors that may be disposed in the contact lens matrix that connect components in the self-contained electronics module to components outside the contact lens matrix. In some embodiments, a portion of the self-contained electronics module itself may be exposed through (or outside of) the contact lens matrix, which may provide access to the components therein without destroying or altering the contact lens matrix.

In some embodiments, in the first device as described above that includes a first lens and a self-contained electronics module that contains an electronic component and a dynamic optic configured to provide at least a first optical power and a second optical power, the self-contained electronics module may further include an electromagnet. As defined above, an “electromagnet” may refer to a type of magnet in which the magnetic field is produced by the flow of electric current. The magnetic field may be removed when the current is turned off. In general, the use of electromagnets, such as to apply a force to a fluid lens or other component of a dynamic optic, may have some advantages—particularly in the context of embodiments comprising an intraocular lens. For instance, electromagnets may have a very small form factor, while still being capable of providing a relatively large force. For example, in some embodiments, a thin layer of ferromagnetic material (as thin as approximately 2-3 microns) may be sufficient. In comparison to other components of a dynamic lens (such as an actuator, pump, or other mechanism that may otherwise be used to move the fluid), the use of an electromagnet may significantly reduce the size of the dynamic optic or components thereof. Moreover, the inventors have found that the use of electromagnets may be preferred in some embodiments, because, for example, electromagnets may not be as susceptible to failure (so long as there remains an electrical connection to supply current or voltage).

In some embodiments comprising an electromagnet, the electromagnet or a portion thereof may be coupled to at least a portion of the dynamic lens. Examples of such embodiments are described below with reference to FIGS. 9 and 10. In general, coupling an electromagnet to a portion of the dynamic lens (for example, to a component the moves or changes shape) may provide an efficient means for transferring the magnetic force created by two components of an electromagnet into a physical force. This can be used to bring two components closer together (e.g. two sides of a fluid holding element so as to remove liquid disposed therein) or to repel objects apart. For instance, some embodiments may directly couple a portion of the electromagnet to a flexible element of a dynamic optic, which is positioned opposite another electromagnet having the same polarity. When current or voltage is applied to the two electromagnets, a repelling force may be created, thereby changing the shape of the flexible element (e.g. increasing the curvature of the flexible element).

In some embodiments, in the first device as described above that includes a first lens and a self-contained electronics module that contains an electronic component and a dynamic optic that comprises a fluid lens configured to provide at least a first optical power and a second optical power, and an electromagnet coupled to at least a portion of the dynamic lens, a first portion of the electromagnet may be disposed outside of the self-contained electronics module and a second portion of the electromagnet may be disposed within the self-contained electronics module. That is, for instance, because the magnetic force may apply through the wall of the self-contained electronics module, embodiments need not include both the first and the second components of an electromagnet within the self-contained electronics module to be effective. For example, the first portion of the electromagnet may be disposed on a region of the contact lens matrix such that, when current or voltage is supplied to the electromagnet, a magnetic force is created between the first and second portions. For instance, in some embodiments, when current or voltage is supplied to at least one of the first portion or the second portion of the electromagnet, the first portion and the second portion may interact with one another. The term “interact with one another,” may refer to when the any magnet force that is applied between the two materials when the electromagnets are activated. That is, when current or voltage is supplied to one or both of the portions, a force may be created between the two portions (which may move the two portions closer together, and/or may apply a force to other components that may be coupled to the first or the second portions of the electromagnet). In some embodiments, the first portion and the second portion may comprise separate electromagnets.

In some embodiments, in the first device as described above that includes a first lens and a self-contained electronics module that contains an electronic component and a dynamic optic that may comprise a fluid lens configured to provide at least a first optical power and a second optical power, and where the first lens includes an electromagnet, the first lens may also comprise a magnetic material. The electromagnet and/or the magnetic material may be disposed within the self-contained electronics module, while the other component may be disposed outside the self-contained electronics module. In some embodiments, when current or voltage is supplied to the electromagnet, the electromagnet and the magnetic material may interact with one another. This is an example of an instance where an electromagnet disposed in the self-contained electronics module may interact with a component disposed outside the self-contained electronics module (but within the first lens).

In some embodiments, in the first device as described above that includes a first lens and a self-contained electronics module that contains an electronic component and a dynamic optic that may comprise a fluid lens configured to provide at least a first optical power and a second optical power, and an electromagnet coupled to at least a portion of the dynamic lens, the optical add power of the dynamic optic may be based at least in part on whether current or voltage is supplied to the electromagnet. For example, the electromagnet, when activated, may apply a force that moves fluid in a dynamic fluid lens, or an electromagnet may apply a force to a flexible element of a dynamic optic so as to change the curvature or shape of the element, and thereby change the optical add power of the device. In general, the use of an electromagnet may be preferred for some applications because it may allow for components to be temporarily moved (or to temporarily apply force) without requiring mechanical parts (such as an actuator or pump mechanism). This may be particularly useful when the device is disposed in a device that requires a small form factor, such as an intraocular lens.

In some embodiments, in the first device as described above that includes a first lens and a self-contained electronics module that contains an electronic component and a dynamic optic that may comprise a fluid lens configured to provide at least a first optical power and a second optical power, the dynamic optic may further include a flexible element that can form a plurality of shapes. For example, the flexible element may comprise a membrane that is comprises a surface of the dynamic optic. In some embodiments, the dynamic optic may provide a plurality of optical add powers for a portion of the first device based at least in part on the shape of the flexible element. As used herein, the “shape of the flexible element” may refer to, for instance, the radius of curvature of the flexible element or a portion thereof, its displacement relative to a fixed element of the lens, and/or the shape of a surface region of the flexible element (e.g. the application of force or electrical current/voltage to the flexible element may create a pattern over the surface of the flexible element that affects the optical path of light through the dynamic optical element).

For example, in some embodiments, the dynamic optic may further include a fluid and a fluid holding element, where the fluid may be disposed within the fluid holding element. The fluid holding element may have a peripheral edge, and the shape of the flexible element may be based at least in part on the amount of force applied to at least a portion of the peripheral edge of the fluid holding element. In general, the “fluid holding element” may contain any amount of fluid. The fluid holding element may be located adjacent to the flexible element (or the flexible element may comprise a part of the fluid holding element, such as one of the sides) such that as fluid is disposed or moved within a cavity, the fluid may apply pressure to the flexible element and thereby change its shape. That is, for instance, the fluid holding element may be the area disposed behind the flexible membrane that may contain fluid, where the amount of fluid may increase or decrease so as to increase or decrease the force applied to the flexible element. In some embodiments, the force that is applied to the edge of the fluid holding element (which may itself comprise a flexible element coupled to a rigid substrate, two flexible elements, a single flexible container such as a bladder, etc.) may force liquid into the center of the dynamic optic, thereby increasing the radius of curvature of the flexible element (e.g. a membrane). An exemplary embodiment is illustrated in FIG. 10 and described herein.

In some embodiments, the self-contained electronics module may further include an electromagnet, where the amount of force applied to the peripheral edge of the fluid holding element may be based at least in part on the amount of current or voltage supplied to the electromagnet. In some embodiments, the electromagnet may be disposed around at least a portion of the peripheral edge of the fluid holding element. That is, embodiments may comprise an electromagnet disposed over the entire periphery of the fluid holding element (such as the exemplary embodiment shown in FIG. 10) or only a portion thereof.

In some embodiments, in the first device as described above that includes a self-contained electronics module that contains an electronic component and (such as an electromagnet) and a dynamic optic, where the dynamic optic comprises a fluid lens having a flexible element, a fluid, and a fluid holding element having a peripheral edge, the fluid disposed in the fluid holding element may apply a first force to a first portion of the flexible element when a current or voltage is supplied to the electromagnet and a second force to the first portion of flexible element when a current or voltage is not supplied to the electromagnet. The first and the second force may be different. In this manner, the electromagnet may be used to apply a force that changes the optical add power of the device. Some embodiments may thereby be advantageous because, for instance, they may provide for a fail safe device in that the added plus optical power of the dynamic optic may only be provided when current or voltage is supplied to the electromagnet. When the current or voltage is no longer applied, the dynamic optic (e.g. the fluid holding element and/or the flexible element) may return to their original shapes.

In some embodiments, in the first device as described above that includes a first lens and a self-contained electronics module that contains an electronic component, an electromagnet and a dynamic optic, where the dynamic optic may comprise a fluid lens having flexible element, a fluid, and a fluid holding element having a peripheral edge, the fluid holding element may include a first region. In some embodiments, fluid may be removed from the first region of the fluid holding element when a current or voltage is not supplied to the electromagnet, and fluid may be applied to the first region of the fluid holding element when a current or voltage is supplied to the electromagnet. The “first region” may refer to a portion of the fluid holding element that may be located away from the peripheral edge (e.g. where a force may be applied by the electromagnet) and may be disposed behind (adjacent to) the flexible element—e.g. the membrane—(or the fluid holding element may comprise the flexible element of the second lens component), such that an increase in fluid to the first region may increase the pressure on a portion of the flexible element, thereby changing its size and hence the plus optical power. For instance, the first region may be located in the center of the dynamic optic, but embodiments are not so limited. In this regard, in some embodiments, the optical add power of the dynamic optic may be increased when fluid is applied to the first region of the fluid holding element, and the optical add power of the dynamic optic may be decreased when fluid is removed from the first region of the fluid holding element. For example, embodiments may comprise a typical membrane lens that has an increase in the radius of curvature when the fluid is added to the fluid holding element (such as a cavity disposed behind the membrane), and decreases when the fluid is removed.

In some embodiments, in the first device as described above that includes a first lens and a self-contained electronics module that contains an electronic component and a dynamic optic that may comprise a fluid lens configured to provide at least a first optical power and a second optical power, the dynamic optic may include a first lens component having a first surface and a second surface, a second lens component comprising a flexible element, and a fluid. In some embodiments, the fluid may be disposed and/or applied between at least a portion of the first lens component and at least a portion of the second lens component. This may include, for instance, an embodiment that comprises a reservoir that holds excess fluid that may not be in use by the dynamic optic. When the dynamic optic is activated, fluid may be applied from the reservoir (which may for instance, comprise a bladder or a fluid holding element) to an area adjacent to the flexible element (such as a fluid cavity). An example of this is provided in FIG. 9, and described herein. Such embodiments may provide advantages such as, for example, that the fluid may be readily applied and removed from the fluid cavity. Moreover, the fluid may be kept outside the main field of view of the user, which may permit different materials and/or larger components to be used then if the fluid holding element was located in directly in the field of view.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, and a fluid that may be applied between the first and the second lens component, a portion of the flexible element of the second lens component may have a first shape when a first amount of fluid is disposed between the first surface of the first lens component and the portion of the flexible element of the second lens component. In some embodiments, the portion of the flexible element of the second lens component may have a second shape when a second amount of fluid is disposed between the first surface of the first lens component and the portion of the flexible element of the second lens component. That is, for example, the flexible element may have any number of shapes, such that it may be considered “tunable” (e.g. continuously or discretely) between the first shape and the second shape based on the amount of fluid that is disposed between the first and the second lens component. In this regard, in some embodiments, the dynamic optic may provide a first optical add power when the portion of the flexible element of the second lens component has the first shape, and the dynamic optic may provide a second optical add power when the portion of the flexible element of the second lens component has the second shape. The optical add power provided by the dynamic optic for one of the shapes may be 0.0 D (i.e. zero add power), such as when substantially all of the fluid may be drained from the fluid cavity. However, as noted above, in some embodiments, when the fluid is substantially removed from the fluid cavity adjacent to the flexible element, the dynamic lens may provide an optical power equal to that of the first surface of the first lens component—which corresponds to dynamic conformal lens embodiments.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, and a fluid that may be applied between the first and the second lens component, where a portion of the flexible element of the second lens component may have a first shape or a second shape based on the amount of fluid that is disposed between the first surface of the first lens component and the portion of the flexible element of the second lens component, the self-contained electronics module may further contain an electromagnet. The electromagnet may be configured to apply or remove fluid disposed between the first surface of the first lens component and a portion of the flexible element of the second lens component based on the current or voltage supplied to the electromagnet. As was described above, an electromagnet may, for instance, be utilized to apply force to a fluid holding element (such as a bladder), where the fluid holding element may be configured to apply and receive fluid from different portions of the fluid lens, including from a fluid cavity that is disposed between a flexible element and a substrate. The electromagnet may be activated or deactivated based on whether a current or a voltage is supplied to the component.

In some embodiments, in the first device as described above that includes a first lens and a self-contained electronics module that contains an electronic component and a dynamic optic that comprises a fluid lens configured to provide at least a first optical power and a second optical power, where the dynamic optic may include a flexible element that can form a plurality of shapes, and wherein the dynamic optic provides a plurality of optical add powers for a portion of the first device based at least in part on the shape of the flexible element, the dynamic optic may further include a fluid and a fluid cavity. The fluid may be applied and removed from the fluid cavity and the shape of the flexible element may be based at least in part on the amount of fluid that is disposed within the fluid cavity. In general, the “fluid cavity” may contain any amount of fluid or no fluid at all. The fluid cavity may be located adjacent to the flexible element such that as fluid enters the fluid cavity, it may apply pressure to the flexible element and thereby alter the shape of the flexible element and, congruently, alter the optical add power provided by the dynamic lens. In some embodiments, the dynamic optic may further include an electromagnet and the amount of fluid that is disposed within the fluid cavity may be based, at least in part, on the amount of current or voltage supplied to the electromagnet. The amount of current and/or voltage applied to the electromagnet may affect the magnetic force applied by the electromagnet (and thereby the force applied to a fluid holding element).

In some embodiments, the fluid may be applied to the fluid cavity when a current or voltage is supplied to the electromagnet, and the fluid may be removed from the fluid cavity when current or voltage is not supplied to the electromagnet. In general this may correspond to embodiments where fluid is stored in a fluid holding element until the lens is activated, at which point fluid may be applied so as to change the shape of a flexible element. An exemplary embodiment is shown in FIG. 9 and described herein. The fluid holding element may be located in any suitable location, but in general it may be advantageous to be disposed relatively close the fluid cavity so that the dynamic optic may be activated and deactivated with reduced delay.

In some embodiments, the fluid may be removed from the fluid cavity when a current or voltage is supplied to the electromagnet, and fluid may be applied to the fluid cavity when current or voltage is not supplied to the electromagnet. That is, in contrast to the above embodiments, the electromagnet may remove fluid from the fluid cavity when the dynamic lens is activated. This may correspond, for instance, to a conformal fluid lens embodiment (e.g. embodiments where fluid is expressed of a region such that the flexible membrane may conform to a fixed component—e.g. the rigid substrate).

In some embodiments, the optical add power of the dynamic optic may be increased when fluid is applied to the fluid cavity, and the optical add power of the dynamic optic may be decreased when fluid is removed from the fluid cavity. This may correspond, for instance, to a typical membrane lens that has an increase in the radius of curvature when the fluid is added to fluid cavity adjacent to the flexible element, and decreases when the fluid is removed.

In some embodiments, the optical add power of the dynamic optic may be decreased when fluid is applied to the fluid cavity, and the optical add power of the dynamic optic may be increased when fluid is removed from the fluid cavity. This may correspond, for instance, to embodiments that comprise a dynamic conformal lens, wherein the flexible element (e.g. membrane) may conform to a surface optical feature when the fluid is removed (which may be masked when there is fluid disposed between the flexible membrane and the surface).

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, and fluid that may be applied between the first and the second lens component, the dynamic optic may further include a fluid holding element configured to receive and apply the fluid from between the first and the second lens components. As defined above, a “fluid holding element” may refer to any component that may retain (or otherwise contain) a fluid. The fluid holding element may be utilized to store fluid that is not currently in use by the dynamic lens to provide optical add power. The fluid holding element may comprise any suitable component, such as a reservoir or a bladder. In general, a “bladder” may refer to a flexible container (typically with a single opening) that may be used to store a fluid. A bladder may increase and decrease in size based on the amount of fluid contained therein. Fluid may be applied from a bladder by applying pressure to one or more parts of the bladder (e.g. squeezing the balder). In some embodiments, the fluid holding element may be configured to have a shape that is based, at least in part, on a force applied to the fluid holding element. The amount of fluid that is applied or received from between the first and the second lens components may be based at least in part on the shape of the fluid holding element.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, a fluid that may be applied between the first and the second lens component, and a fluid holding element, the self-contained electronics module may further include an electromagnet that may be configured to apply a force to the fluid holding element when current or voltage is supplied to the electromagnet. In some embodiments, the fluid holding element may comprise the electromagnet or a portion thereof. For example, the electromagnetic material may be deposited as one or more layers on a portion of the fluid holding element. As described above, coupling the electromagnetic material to the fluid holding element may comprise an efficient manner in transferring the magnetic force between one or more electromagnets, to a physical force. The magnetic material may be depositing on opposite sides of the fluid holding element (and/or on the inner or outer surfaces), such that when current is applied to the electromagnet, the two sides may be moved toward each other and apply pressure to the fluid holding element. In some embodiments, only one side may be an electromagnet, and the other component could be a permanent magnetic material.

In some embodiments, the material of the electromagnet may comprise a ferromagnet. In some embodiments, the layer of magnetic material may have a thickness that is between approximately 1 and 5 microns. As noted above, the use of an electromagnet may provide the advantage that the electromagnet may require only a small amount of space. This may be particularly important when the device comprises an intraocular lens. The inventors have generally found that electromagnet materials may be effective at relatively small thickness. This, in some embodiments, the thickness of the layer may be between approximately 2 and 3 microns. In some embodiments, the material of the electromagnet may comprise anyone of, or some combination of: Mn doped ZnO layers; Yttrium Iron Garnet (YIG) layers; and La_{0.3}A_{0.7}MnO₃, where A may be Ba²⁺, Ca²⁺, or Sr²⁺. However, embodiments are not so limited, and any suitable electromagnetic material may be used.

In some embodiments, in the first device as describe above, the electromagnet may include a first component and a second component. The first component or the second component of the electromagnet may be configured so as to magnetize when an electrical field is applied across each component. The first and the second components of the electromagnet may be configured to move relative to one another when magnetized. As used herein, the term “moving relative to one another” may comprise, for instance, only one component that is moved while the other component remains fixed, or both components could move simultaneously.

In some embodiments, in the first device as described above that includes a first lens and a self-contained electronics module that contains an electronic component and a dynamic optic configured to provide at least a first optical power and a second optical power, where the dynamic optic includes a first lens component, a second lens component having a flexible element, a fluid that may be applied between the first and the second lens component, and a fluid holding element, where the self-contained electronics module contains an electromagnet having a first component and a second component, at least a portion of the fluid holding element may be disposed between the first component and the second component of the electromagnet. That is, for instance, the electromagnet need not, in some embodiments, apply a force across the entire fluid holding element to effectively displace fluid and alter the optical add power provided by the dynamic optic, but may apply force to only a portion of the fluid holding element. The first component and the second component of the electromagnet may be at a first distance when no voltage or current is supplied to the electromagnet; and at a second when a first voltage or current is supplied to the electromagnet, where the first distance may be different than the second distance. That is, the first and the second component of the electromagnet may move closer based on the force applied by the magnetic field, and in the process may alter the shape of any components that are disposed there between.

In some embodiments, in the first device as described above that includes a first lens and a self-contained electronics module that contains an electronic component and a dynamic optic configured to provide at least a first optical power and a second optical power, where the dynamic optic may comprise a fluid lens, the first device may further include a contact lens matrix. In some embodiments, the contact lens matrix may include a first surface and a second surface, where the first surface and the second surface may be disposed so as to create a first region between them. The self-contained electronics module may be disposed within the first region. For example, the contact lens matrix may be manufactured as two separate components (or as a single component having cavity). The self-contained electronics module may then be disposed within the contact lens matrix, at which point the contact lens matrix may be sealed. As noted above, an advantage that some embodiments that comprise a self-contained electronics module may provide is, for example, that the electronics module may be inserted into a contact lens matrix without significant fabrication costs/effort. Another benefit is that the manufacturing process may be more robust in that, for example, if during the manufacture of the contact lens matrix, an error occurs, there may be no need to replace the expensive components such as the dynamic lens or electronics that would otherwise be destroyed in such a process.

In some embodiments, in the first device as described above that includes a first lens and a self-contained electronics module that contains an electronic component and a dynamic configured to provide at least a first optical power and a second optical power, where they dynamic optic may comprise a fluid lens, the dynamic optic may provide a portion of a near distance optical power for a wearer when activated. The first device may provide a far distance optical power for a wearer when the dynamic optic is not activated. Indeed, this may be ideal in that a single intraocular lens may provide both the near distance and the far distance optical power needed by a wearer. In some embodiments, the dynamic optic may provide an optical add power of at least 0.5 diopters when activated. In some embodiments, the dynamic optic may provide an optical add power of at least 1.0 diopter when activated. In some embodiments, the dynamic optic may provide an optical add power of at least 2.0 diopters when activated.

In some embodiments, the near distance optical power and the far distance optical power may each be focused on the retina at different times. As was described above, the current commercially available multifocal intraocular lenses create two images that are focused on the retina simultaneously. This may be confusing to a wearer and may be less then ideal. By providing an intraocular lens that comprises a dynamic optic, embodiments described herein may address this issue by providing a wearer with the correct optical add power for the object distance that they are presently viewing, without the confusion of multiple images.

In some embodiments, in the first device as described above that may include a first lens and a self-contained electronics module that contains an electronic component and a dynamic optic configured to provide at least a first optical power and a second optical power, where the dynamic optic may comprise a fluid lens, and where the self-contained electronics module may contain a power supply; a controller; and/or a sensing mechanism, the self-contained electronics module may further include a charging module that is configured to charge the power source. The charging module may generally refer to and component or components that may be used to provide addition electrical charge to the power source. In some embodiments, the charging module may be configured to charge the power source using induction or kinetic energy. Examples of this are described below with reference to FIGS. 1, 3, 12, and 13-14. Moreover, the use of kinetic energy and/or induction may provide the benefit of enabling an intraocular lens to be utilized for an extended period time, without replacing the power source (which may be difficult or infeasible to do). In some embodiments, the charging module may include at least one induction coil that is electrically coupled to the power source. An induction coil may use a rotating or oscillating magnetic field (e.g. like that which may be generated by a magnetic object passing through the coil) to generate charge. In some embodiments, the induction coil may be configured to remotely charge the power supply. For example, a contact lens case or special goggles may create a rotating magnetic field that may charge the device.

In some embodiments, in the first device as described above that includes a first lens and a self-contained electronics module that contains an electronic component and a dynamic optic configured to provide at least a first optical power and a second optical power, where the self-contained electronics module contains a power supply, the power supply may comprise a battery. In some embodiments, the power supply may comprise a capacitor. In generally, the power source may comprise any suitable device, and may be located in any suitable location. Although it may be preferred that the power be located inside the self-contained electronics module so as to not require electrical connections from the power source to the dynamic optic and/or the other electronics, embodiments are not so limited.

In some embodiments, in the first device as described above that includes a first lens and a self-contained electronics module that contains an electronic component and a dynamic optic configured to provide at least a first optical power and a second optical power, where the self-contained electronics module includes a controller, the controller may comprise a micro application-specific integrated circuit (ASIC). The controller may receive input from the sensor mechanism (which may provide a variety of information, such as the direction of the gaze of the user, etc.) and may compare this with pre-stored instructions or routines to determine whether to activate or deactivate the dynamic lens.

In some embodiments, in the first device as described above that includes a first lens and a self-contained electronics module that contains an electronic component and a dynamic optic configured to provide at least a first optical power and a second optical power, where the self-contained electronics module may contain a sensing mechanism, the sensing mechanism may comprise one or more photodiodes. In some embodiments, the sensing mechanism may determine whether an eye lid is closed and/or how long the eye lid has been closed. In some embodiments, the sensing mechanism may electrically transmit a signal to a controller based on the determination of how long the eye lid has been closed. In some embodiments, the sensing mechanism may measure the amount of light that is reflected out of the eye. As noted above, the sensing mechanism may generally collect any relevant information and may pass this information to the controller for a determination as to whether to act.

In some embodiments, in the first device as described above that includes a first lens and a self-contained electronics module that contains an electronic component and a dynamic optic configured to provide at least a first optical power and a second optical power, where the self-contained electronics module may contain a power supply, the first device may further include an inductive coil configured to charge the power supply. As noted above, the use of inductive coils may generally provide the benefit of longer lifetime for the device (that is, the power source may not be the limiting factor of the device).

In some embodiments, in the first device as described above that includes a first lens and a self-contained electronics module that contains an electronic component and a dynamic optic configured to provide at least a first optical power and a second optical power, the first device may comprise a contact lens. However, embodiments are not so limited. Indeed, the embodiments disclosed herein and related concepts may have applicability in other fields of optics.

In some embodiments, in the first device as described above that includes a first lens and a self-contained electronics module that contains an electronic component and a dynamic configured to provide at least a first optical power and a second optical power, the dynamic optic may comprise any one of, or some combination of: a diffractive optic; a pixilated optic; a refractive optic; a tunable liquid crystal optic; a shaped liquid crystal layer; a shaped liquid layer; a liquid lens; and/or a conformal liquid lens. As defined above, the dynamic optic may broadly cover any dynamic optical component or device such that the optical add power provided may change.

In some embodiments, in the first device as described above that includes a first lens and a self-contained electronics module that contains an electronic component and a dynamic optic configured to provide at least a first optical power and a second optical power, the self-contained electronics module may have a thickness that is less than approximately 200 microns. As was described in detail above, embodiments of the device may comprise an intraocular lens, where there may be limited space that may b utilized without affecting the comfort of the device. The inventors have generally found that a device that has a thickness of less than 200 microns is generally sufficient to be used in most applications (that is, the self-contained electronics module may reasonably fit within most intraocular lenses without causing irritation to the wearer). However, it may be preferred that the thickness of the self-contained module be maintained as small as possible. Thus, in some embodiments, the self-contained electronics module may have a thickness that is between approximately 15 and 150 microns. In some embodiments, the self-contained electronics module may have a thickness that is between approximately 65 and 90 microns thick. The thickness of the electronics module may depend on a variety of factors, including the components disposed therein (particularly the dynamic optic), as well at the materials chosen for the module itself.

In some embodiments, a first device may be provided. The first device May include a self-contained electronics module having a thickness that is less than approximately 125 microns. The self-contained electronics module may contain a dynamic optic (or portion thereof) that may be configured to provide at least a first optical power and a second optical power, where the first optical power is different than the second optical power. The electronics module may also include an electronic component, where the electronic component may be configured to drive the dynamic optic. In some embodiments, the electronics module may have a thickness that is less than approximately 90 microns. In some embodiments, the electronics module may have a thickness that is less than approximately 60 microns.

In some embodiments, in the first device as described above having a self-contained electronics module that includes a dynamic optic, where the self-contained electronics module has a thickness that is less than approximately 125 microns, the dynamic optic may comprise a fluid lens. However, as was described in detail above, embodiments are not so limited, and may provide a dynamic optic that utilizes any suitable method.

In some embodiments, in the first device as described above having a self-contained electronics module that contains a dynamic optic, where the self-contained electronics module has a thickness that is less than approximately 125 microns, the self-contained electronics module may contain one or more micro nanotubes. In some embodiments, the self-contained electronics module may contain an electromagnet. As noted above, the use of an electromagnet may provide the advantage in some instances of applying a force to components of a dynamic optic, while maintaining a relatively small form factor. For example, an electromagnet may comprise a thin layer of electromagnetic material (e.g. less than approximately 5 microns in thickness) and one or more conductors to supply current or voltage. This may be readily disposed in a 125 micron thick electronics module (or smaller embodiments), along with any additional electronic components and/or or the dynamic lens.

In some embodiments, in the first device as described above having a self-contained electronics module that contains a dynamic optic, where the self-contained electronics module has a thickness that is less than approximately 125 microns, the dynamic optic may comprise any one of, or some combination of a diffractive optic; a pixilated optic; a refractive optic; a tunable liquid crystal optic; a shaped liquid crystal layer; a shaped liquid layer; a fluid lens; or a conformal liquid lens. As was described above, the dynamic optic may comprise any suitable dynamic lens; however, the inventors have generally found that by limiting the thickness of the components of the host lens (including the electronics module and/or the dynamic optic), the device may be more comfortable for a wearer and function more efficiently.

In some embodiments, in the first device as described above having a self-contained electronics module that contains a dynamic optic, where the self-contained electronics module has a thickness that is less than approximately 125 microns, the dynamic optic may be discretely switchable between the first optical power and the second optical power. Exemplary switchable dynamic optics may include, by way of example, a device that may simply be “ON” or “OFF” (e.g. when a predetermined and fixed current or voltage is supplied, the device may have a first optical power; and when the predetermined and fixed voltage or current is not supplied, the device may have a second optical power). In some embodiments, the dynamic optic may be continuously tunable between the first optical power and the second optical power. This may comprise, for instance, dynamic lenses that allow a variable amount of current or voltage to be supplied, thereby providing a continuum of optical add powers.

In some embodiments, in the first device as described above having a self-contained electronics module that contains a dynamic optic, where the self-contained electronics module has a thickness that is less than approximately 125 microns, the first device may comprise a contact lens or an intraocular lens. As noted above, for embodiments that are used included within the wearer's eye or directly adjacent to, it is generally desirable to reduce the size of such devices (including the electronics module that may contain one or more electronic components and/or the dynamic optic). However, embodiments are not so limited, and some of the features, components, and methods described herein may have applicability in other applications, such as in eyeglasses (e.g. spectacles), and large scale optical systems that may utilized one or more dynamic lenses.

In some embodiments, a first contact lens may be provided. The first contact lens may include a sealed self-contained electronic module. The sealed self-contained electronic module may include a dynamic optic. As noted above, although embodiments may not be limited to contact lens embodiments, the use of such methods and devices disclosed herein may provide some advantages over devices currently available, including for example removing double images from multifocal contact lenses and/or increased efficiency in manufacturing.

In some embodiments, in the first contact lens as described above that includes a sealed self-contained electronic module that comprises a dynamic optic, the dynamic optic may be that of a diffractive optic. In some embodiments, the dynamic optic may be that of a refractive optic.

In some embodiments, the dynamic optic may be that of a liquid optic. In some embodiments, the dynamic optic may be that of a tunable liquid crystal. In some embodiments, the dynamic optic may be that of a shaped liquid crystal optic. In some embodiments, the dynamic optic may be that of a Fresnel optic. As noted above, the dynamic optic may comprise any suitable type of lens or features therein.

In some embodiments, in the first contact lens as described above that includes a sealed self-contained electronic module that comprises a dynamic optic, where the dynamic optic comprises a liquid optic, the liquid optic may change optical power by way of an electronic magnet. In some embodiments, the electronic magnet may comprise of a deposition coating. The use of electromagnets, as described above, may provide advantages regarding the size and function of the dynamic optic.

In some embodiments, in the first contact lens as described above that includes a sealed self-contained electronic module that comprises a dynamic optic, the self-contained electronic module may be sealed in glass.

In some embodiments, in the first contact lens as described above that includes a sealed self-contained electronic module that comprises a dynamic optic, the self-contained electronic module may be charged remotely. For instance, a device may generate a rotating or variable magnetic field, and the self-contained electronics module may comprise one or inductors or inductive loops such that charge may be generated. However, any suitable method of remotely charging may be used, including those described above.

In some embodiments, in the first contact lens as described above that includes a sealed self-contained electronic module that comprises a dynamic optic, the self-contained electronic module may be charged by one of induction or kinetic energy. In some embodiments, where the module is charged by induction, the inductive charger may be that of one of: a contact lens case; an eye mask; or eyeglasses. In some embodiments, kinetic energy may be used to generate electric charge through the use of conductors (such as some forms of nanotubes) and/or a magnetic element that may move over through (or between) the conductors. However, ay suitable method may be used, including those described above.

In some embodiments, in the first contact lens as described above that includes a sealed self-contained electronic module that comprises a dynamic optic, the self-contained electronic module may be stabilized so as to reduce rotation. An example of an embodiment comprising a stabilizer component is shown and described below with respect to FIG. 4. By stabilizing the rotation of the contact lens, embodiments may provide for more accurate use of the sensing mechanisms, particularly mechanisms that may be used to measure the blink of the wearer.

In some embodiments, in the first contact lens as described above that includes a sealed self-contained electronic module that comprises a dynamic optic, the first contact lens may include a dynamic optic and a central aspheric optical power region. The central aspheric optical power zone may comprise the area of the contact lens which be in optical communication with the dynamic optic, such that when the dynamic optic is activated, the central aspheric optical power region may provide a wearer with an optical power that includes the optical add power provided by the dynamic optic (in addition to the optical power provided by any other components that are also in optical communication with the central aspheric optical power region).

In some embodiments, in the first contact lens as described above that includes a sealed self-contained electronic module that comprises a dynamic optic, the first contact lens may be capable of correcting for the distance optical power of a wearer and separately the near optical power of the wearer, and whereby the distance and the near optical power may each be focused on the retina at different times.

### DESCRIPTION OF THE FIGURES

Reference will now be made to FIGS. 1-12 to further describe various embodiments of a device (such as an intraocular lens) that comprise a self-contained electronics module. The figures and corresponding description are provided as examples of embodiments and/or examples of operation of a dynamic optic. The figures and the descriptions herein are for illustration purposes and are not intended to be limiting.

FIG. 1 shows a front view of an exemplary device in accordance with some embodiments described herein. The exemplary device 100, having an outer perimeter 103, is shown as comprising a contact lens that includes a dynamic optic 101; a self-contained electronics module (the outer perimeter of which is shown as 102); photo-detectors 104; a capacitor 105; a micro magnetic ball or member 106; and a kinetic energy source 107. As shown in this example, the self-contained electronics module is disposed within the outer perimeter 103 of the contact lens 100 (i.e. it is disposed within the contact lens matrix). The dynamic optic 101, photo-detectors 104; capacitor 105; micro magnetic ball or member 106; and the kinetic energy source 107 are each shown as disposed within the self-contained electronics module outer perimeter 102. As shown in FIG. 1, the dynamic optic (or the power source—e.g. capacitor 105—that provides power to the dynamic optic 101) may be energized based on the kinetic energy source 107. In this exemplary embodiment, the kinetic energy source 107 utilizes the motion of a metallic element (e.g. the micro-magnetic ball or member 106), which may be induced by vibration, along a track and through a magnetic coil (not shown). The energy generated by the kinetic energy source 107 may be stored and delivered to the dynamic lens by the capacitor 105. In this exemplary embodiment, the sensors are photo-detectors 104 that may be used to the detect level of ambient illumination. The photo-detectors 104 may then send signals that indicate the level of illumination to a controller (not shown), which may then determine whether to activate the dynamic lens 101. The dynamic lens 101 is shown as diffractive electro-active element, but as noted above, may comprise any suitable lens including for example a Fresnel, a pixilated, or a shaped liquid crystal, etc. The capacitor 105 (or similar power source) may be electrically connected to any components that may utilize electricity, such as the dynamic optic 101, the photo-detectors 104 (or other sensor), the controller, etc. The electrical connection may be made, by way of example only, using a transparent or semi-transparent conductor such as ITO.

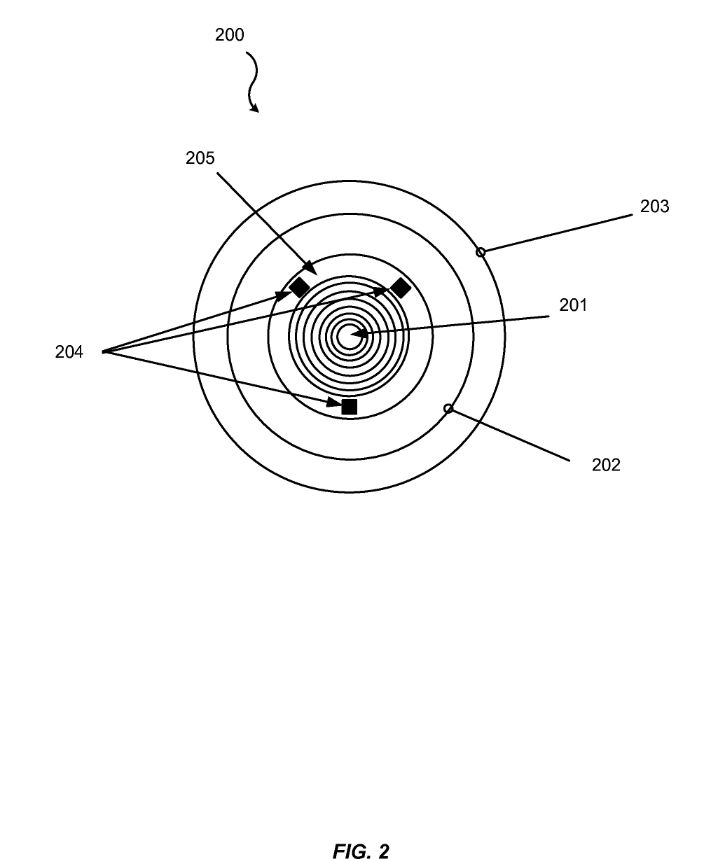

FIG. 2 shows a front view of an exemplary device in accordance with some embodiments described herein. The exemplary device 200, having an outer perimeter 203, is shown as comprising a contact lens that includes a dynamic optic 201 (which is shown as comprising a diffractive electro-active element, but could for example comprise a Fresnel, pixilated, or shaped liquid crystal layer); a self-contained electronics module (the outer perimeter of which is shown as 202); photo-detectors 204; and a capacitor 205. As shown in this example, the self-contained electronics module is disposed within the outer perimeter 203 of the contact lens 200 (i.e. it is disposed within the contact lens matrix). The dynamic optic 201, photo-detectors 204; and capacitor 205 (which shown in this example as a ring around the dynamic optic 201; however, embodiments are not so limited) are each shown as disposed within the self-contained electronics module outer perimeter 202. Unlike the embodiment shown in FIG. 1, the device in FIG. 2 does not show a component or device for charging the capacitor 205 (in some embodiments, the capacitor 205 may be replaced by a battery). Thus, FIG. 2 may represent an embodiment whereby the intraocular lens 200 is disposable (e.g. once the wearer uses the intraocular lens 200 for a certain amount of time, or the charge is exhausted from the power source—e.g. capacitor 205—the device 200 may be discarded). In some embodiments, although not shown in FIG. 2, the self-contained electronics module may comprise a piezoelectric generator that feeds energy (e.g. generates and provides current or voltage) to the capacitor 205 (which may, for instance, be a super capacitor comprising carbon nanotubes or graphene layers with surface charge built by complexing counterions to the inner surface). However, any suitable power source may be used, such as a rechargeable battery. An example of a piezoelectric generator was discussed above with reference to FIGS. 13(a) and (b).

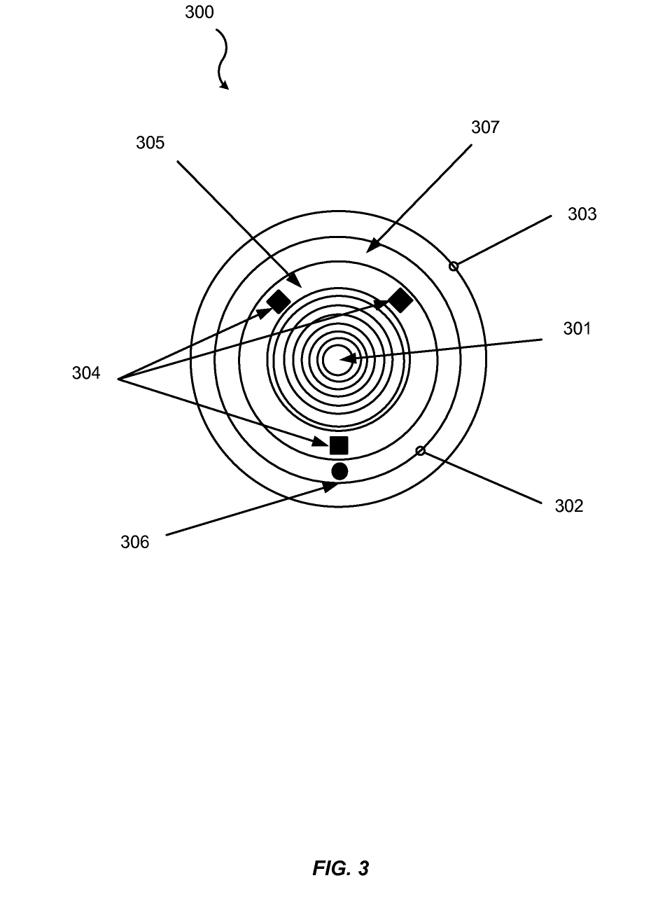

FIG. 3 shows a front view of an exemplary device in accordance with some embodiments described herein. The exemplary device 300, having an outer perimeter 303, is shown as comprising a contact lens that includes a dynamic optic 301 (which is shown as comprising a diffractive electro-active element, but could for example comprise a Fresnel, pixilated, or shaped liquid crystal layer); a self-contained electronics module (the outer perimeter of which is shown as 302); photo-detectors 304; a capacitor 305; a micro magnetic ball or member 306; and a kinetic energy source 307. As shown in this example, the self-contained electronics module is disposed within the outer perimeter 303 of the contact lens 300 (i.e. it is disposed within the contact lens matrix). The dynamic optic 301, photo-detectors 304; capacitor 305; micro magnetic ball or member 306; and the kinetic energy source 307 are each shown as disposed within the self-contained electronics module outer perimeter 302. Similar to FIG. 1, the dynamic optic (or the power source—e.g. capacitor 305—that provides power to the dynamic optic 301) may be energized based on the kinetic energy source 307. As shown, the exemplary embodiment in FIG. 3 utilizes the motion of a metallic element (e.g. the micro-magnetic ball or member 306). However, unlike FIG. 1, in this exemplary embodiment the micro-magnetic ball or member 306 is not shown as being located on a track that may circulate around all (or a portion thereof) the self-contained electronics module, but may be more localized (e.g. the micro-magnetic ball or member 306 may vibrate or move within a small portion of the kinetic energy source 307). However, any suitable method of generating electricity using a kinetic energy source (or any other suitable means) may be used. The kinetic energy source 307 may be in electrical communication (i.e. there may be a conductive path that enables current to flow between two or more elements) with the capacitor 305 and/or the photo-detectors 304 that monitor the pupillary constriction upon application of an accommodative stimulus.

FIG. 4 shows a front view of an exemplary device in accordance with some embodiments described herein. The exemplary device 400, having an outer perimeter 403, is shown as comprising a contact lens that includes a dynamic optic 401 (which is shown as comprising a diffractive electro-active element, but could for example comprise a Fresnel, pixilated, or shaped liquid crystal layer); a self-contained electronics module (the outer perimeter of which is shown as 402); photo-detectors 404; and a capacitor 405. As shown in this example, the self-contained electronics module may be disposed within the outer perimeter 403 of the contact lens 400 (i.e. it is disposed within the contact lens matrix). The dynamic lens 401, photo-detectors 404; and capacitor 405 (shown in this example as a ring around the dynamic optic 401; however, embodiments are not so limited) are each shown as disposed within the self-contained electronics module outer perimeter 402. Similar the device in FIG. 2, the contact lens 400 does not comprise a component or device for charging the capacitor 405 (in some embodiments, the capacitor 405 may be replaced by a battery). Thus, similar to FIG. 2, the device in FIG. 4 could represent an embodiment whereby the intraocular lens 400 is disposable (e.g. once the wearer uses the intraocular lens 400 for a certain amount of time, or the charge is exhausted from the power source—e.g. capacitor 405—the device 400 may be discarded). However, embodiments are not so limited, and any suitable power source and/or power generation element may be used as described above.

The exemplary device 400 in FIG. 4 further includes a weight imbalance 408 (shown as a prism wedge) that stabilizes the contact lens 400 in a preferred orientation to which the lens may return after a blink by the wearer. The prism wedge 408 may comprise, for instance, the thickening of the host material of the intraocular lens 400 near, or on, the self-contained electronics module. However, any suitable weight may be used. As described above, in some embodiments, the prism wedge 408 may comprise a power source (such as battery) and there may be an electrical connection from the battery (which may be disposed outside the perimeter 402 of the self-contained electronics module) to one or more components disposed within the self-contained electronics module. This may be an example of an embodiment where, although the self-contained electronics module may be “sealed,” there may still be some interaction with a component disposed outside of the self-contained electronics module. Thus, as used herein, the self-contained electronics module may be “sealed” in some embodiments if it is configured such that the components disposed therein may not be removed from the module without altering the structure of the self-contained module. However, the components disposed there may not be completely isolated from external components, and may be electrically or otherwise coupled thereto.

FIG. 5 shows a side view of an exemplary device in accordance with some embodiments described herein. The exemplary device 500 comprises a first surface (e.g. front curve) 513 having a radius of curvature R1; a second surface (e.g. second curve) 514 having a radius of curvature R2; and a sealed self-contained electronics module 510. The device 500 also comprises a host material 511 (e.g. a host contact lens material, which may be soft or rigid), that is shown as substantially encapsulating the self-contained electronics module 510. The host material and the radius of curvatures R1 and R2 may provide an optical power, such as the far distance prescription of a user, but embodiments are not so limited. For example, the static optic provided by these components may be modified to include a central radially symmetric zone of variable power characterized by a variable negative spherical aberration. The self-contained electronics module 510 may comprise a dynamic optic that comprises some, or all, of the aspheric positive optical power addition zone 512. That is, as shown in FIG. 5, light (shown as arrows 530) may enter the contact lens 500 at the aspheric positive optical power addition zone and pass through the dynamic optic such that, when the dynamic optic is activated, the light may be refracted according to the optical add power provided by the dynamic optic (and any other optical components that are in optical communication with the dynamic optic. The exemplary device 500 also illustrates that in some embodiments, the self-contained electronics module 510 may be isolated from the wearer's eye by the host material 511, which may permit a wider range of materials to be used for the self-contained electronics module 510 and/or the components therein.

FIG. 6 shows a side view of an exemplary device in accordance with some embodiments described herein. The exemplary device 600 comprises a first surface (e.g. front curve) 613 having a radius of curvature R1; a second surface (e.g. second curve) 614 having a radius of curvature R2; and a sealed self-contained electronics module 610. The device 600 also comprises a host material 611, which is shown as comprising both a rigid material 611(a) and a soft material 611(b). This exemplary hybrid construction, in which a rigid segment 611(a) may be embedded into a soft segment 611(b), may provide renewal of the tear film after the lens is displaced and rotated through eyelid motion. In addition, the rigid segment 611(a) may provide a stable environment for the electronics module 610. The host material and the radius of curvatures R1 and R2 may provide an optical power, such as the far distance prescription of a user, but embodiments are not so limited. The self-contained electronics module 610 may comprise a dynamic optic that comprises some, or all, of the aspheric positive optical power addition zone 612.

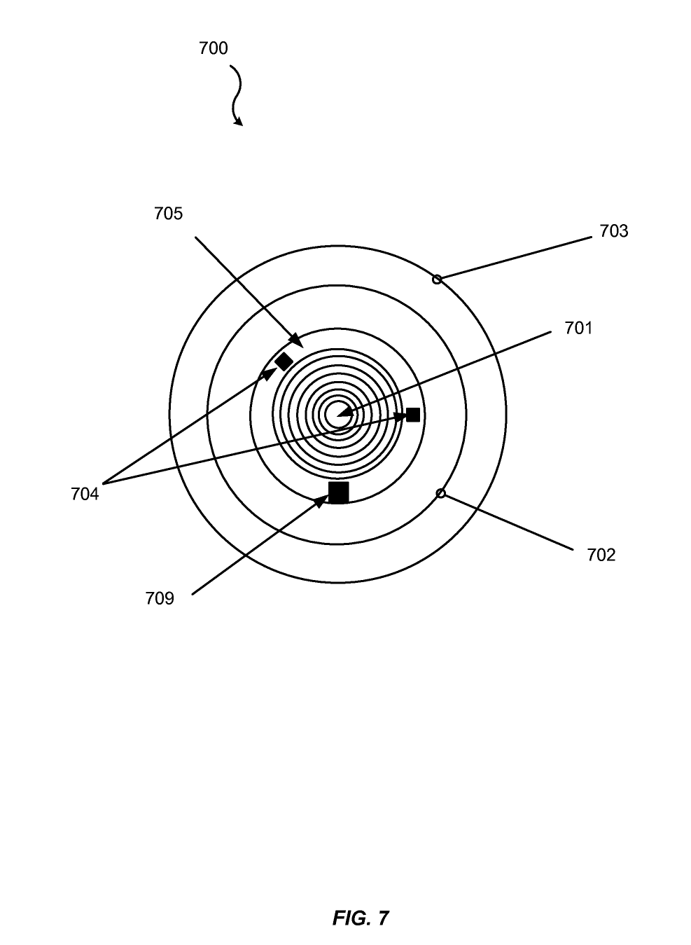

FIG. 7 shows a front view of an exemplary device in accordance with some embodiments described herein. The exemplary device 700, having an outer perimeter 703, is shown as comprising a contact lens that includes a dynamic optic 701 (which is shown as comprising a diffractive electro-active element, but could for example comprise a Fresnel, pixilated, or shaped liquid crystal layer); a self-contained electronics module (the outer perimeter of which is shown as 702); photo-detectors 704; a capacitor 705; and a micro-battery 709. As shown in this example, the self-contained electronics module may be disposed within the outer perimeter 703 of the contact lens 700 (i.e. it is disposed within the contact lens matrix). The dynamic lens 701, photo-detectors 704; capacitor 705 (shown in this example as a ring around the dynamic optic 701; however, embodiments are not so limited); and micro-battery 709 are each shown as disposed within the self-contained electronics module outer perimeter 702. In this exemplary embodiment, energy may be supplied by the micro-battery 709 and the capacitor 705 may be used to amplify the voltage supplied. This may enable a smaller and/or less expensive battery 709 to be used while supplying a higher voltage. The use of a higher voltage may decrease the switching time for activating the dynamic lens 701. As noted above, sensing may be accomplished by the set of photo-detectors 704 that may detect retinal illuminance.

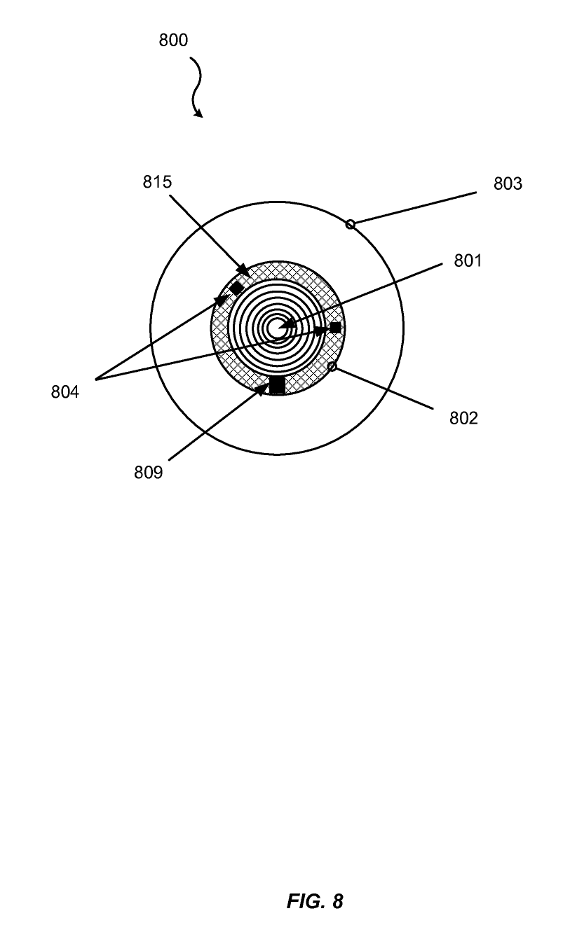

FIG. 8 shows a front view of an exemplary device in accordance with some embodiments described herein. The exemplary device 800, having an outer perimeter 803, is shown as comprising a contact lens that includes a dynamic optic 801 (which is shown as comprising a diffractive electro-active element, but could for example comprise a Fresnel, pixilated, or shaped liquid crystal layer); a self-contained electronics module (the outer perimeter of which is shown as 802); photo-detectors 804; micro-nanowires 815; and a micro-battery 809. As shown in this example, the self-contained electronics module may be disposed within the outer perimeter 803 of the contact lens 800 (i.e. it is disposed within the contact lens matrix). The dynamic lens 801, photo-detectors 804; micro-nanowires 815; and micro-battery 809 are each shown as disposed within the self-contained electronics module outer perimeter 802. In this exemplary embodiment, the micro-nanowires 815 (which may comprise any suitable material such as, for example, ZnO) may be utilized to generate energy that may be stored in the micro-battery 809. Again, as shown in FIG. 8, sensing may be accomplished by the set of photo-detectors 804 that may detect retinal illuminance.

FIG. 9 shows a front view of an exemplary device in accordance with some embodiments described herein. The exemplary device 900, having an outer perimeter 903, is shown as comprising a contact lens that includes a dynamic optic 901 (which is shown as comprising fluid optic that may have a flexible element having a convex curvature that may vary based on the amount of fluid applied to the fluid cavity adjacent to the flexible element); a self-contained electronics module (the outer perimeter of which is shown as 902); photo-detectors 904; capacitor 905 (shown as comprising induction coils); an electromagnet 916; an electronic controlled fluid holding element 917 (e.g. an electronic controlled bladder or reservoir); and a liquid conduit 918. As shown in this example, the self-contained electronics module may be disposed within the outer perimeter 903 of the contact lens 900 (i.e. it is disposed within the contact lens matrix). The dynamic lens 901, photo-detectors 904; capacitor 905; the electromagnet 916; the electronic controlled fluid holding element (e.g. bladder or reservoir) 917; and the liquid conduit 918 are each shown as disposed within the self-contained electronics module outer perimeter 902.

In this exemplary embodiment, the electronic controlled fluid holding element 917 may comprise a material that permits the shape and/or volume of the element to change based on the application of a force to its surface (for example, it may comprise a flexible membrane such as a rubber bladder). The electromagnet 916 may have components (i.e. a first component and a second component) disposed on opposing sides of the electronic controlled fluid holding element 917 (e.g. membrane or rubber bladder) such that when current or voltage is supplied to the first and/or second component (e.g. from capacitor 905 via one or more conductive paths), a magnetic field may be created. The magnetic filed may result in an attractive (or repelling force) between the two components (which may each comprise a ferromagnetic material). The force may be applied to the portions of the electronic controlled fluid holding element 917 that are disposed between the two components of the electromagnet 916, which may then apply fluid from the fluid holding element 917 through the fluid conduit 918 and into the central region of the dynamic optic 901 (which may comprise a fluid cavity). The dynamic optic 901 may comprise a flexible element (such as a membrane) that may have its radius of curvature change based on the amount of fluid that is applied to the fluid cavity located in the central region of the dynamic optic 901. That is, for instance, when electromagnet 916 “closes,” (i.e. the two components move together), the front and back surfaces (or layers) of the electronic controlled fluid holding element 917 may pull together and fluid may be forced toward the center of the dynamic optic 901 thus causing the convex curvature to bulge and increasing plus power. In this manner, dynamic optic 901 may provide optical add power to at least a portion of the contact lens 900.

When the dynamic optic 901 is to be deactivated, the current or voltage may no longer be supplied to the electromagnet 916, which may remove the magnetic field and thereby the force that was applied to the electronic controlled fluid holding element (e.g. the membrane or rubber bladder) 917. The fluid that had been applied to the fluid cavity in the central optic region of the dynamic optic 901 may then return through the fluid conduit 918 to the reservoir 917. That is, when the electromagnet 916 opens, the process is reversed.

As was described above, the electromagnet 916 may be coupled to the electronic controlled fluid holding element 917 in any suitable manlier, including, for example, being deposited as one or more layers of a ferromagnetic material on the inner or outer surfaces. However, embodiments are not so limited. For instance, in some embodiments, one of the components of the electromagnet 916 may comprise a permanent magnet, such that a force may be created between the first and the second components when current is supplied to only one component. Again, as shown in this exemplary embodiment, sensing may be accomplished by the set of photo-detectors 904 that may detect retinal illuminance. Current or voltage may be supplied to the electromagnet 916 based on signal generated by the photo-diodes 904.

FIG. 10 shows a front view of an exemplary device in accordance with some embodiments described herein. The exemplary device 1000, having an outer perimeter 1003, is shown as comprising a contact lens that includes a dynamic optic 1001 (which is shown as comprising fluid optic that may have a flexible element having a convex curvature that may vary based on the amount of fluid applied to the fluid cavity (or a portion thereof) adjacent to the flexible element); a self-contained electronics module (the outer perimeter of which is shown as 1002); photo-detectors 1004; capacitor 1005 (shown as comprising induction coils); and an electromagnet 1016 (shown as being disposed on the peripheral edge 1031 of the convex and concave side of the dynamic optic 1001). As shown in this example embodiment, the self-contained electronics module may be disposed within the outer perimeter 1003 of the contact lens 1000 (i.e. it is disposed within the contact lens matrix). The dynamic lens 1001, photo-detectors 1004; capacitor 1005; and the electromagnet 1016 are each shown as disposed within the self-contained electronics module outer perimeter 1002.

In this exemplary embodiment, the dynamic optic 1001 may include an electronic controlled fluid holding element that may comprise a material that permits the shape and/or volume of the fluid holding element to change based on the application of a force to its surface (for example, it may comprise a flexible membrane such as a rubber bladder). However, unlike the exemplary embodiment in FIG. 9, the fluid holding element in this exemplary embodiment may not function as a reservoir for receiving and applying fluid to the fluid cavity to change the convex curvature of the flexible element of the dynamic optic 1001, but may itself comprise the flexible element (e.g. corresponding to one of its surfaces) that changes curvature to provide a change in the optical add power. That is, as shown in FIG. 10, the fluid may be disposed in the central optical area of the dynamic optic (corresponding to the fluid cavity that is adjacent to the flexible element). Thus, the fluid may remain in the fluid holding element even as the dynamic optic is activated and deactivated; however, the shape of the fluid holding element (and thereby the flexible element) may vary based on the location of and/or force applied to the fluid (which may be controlled by applying force to the surface of the fluid holding element).

The electromagnet 1016 may have components (i.e. a first component and a second component) disposed on opposing sides (e.g. the convex and concave sides) of the peripheral edge 1031 of the fluid holding element of the dynamic optic 1001 such that when current or voltage is supplied to the first and/or second component (e.g., from capacitor 1005 via one or more conductive paths), a magnetic field may be created. The magnetic filed may result in an attractive (or repelling force) between the two components (which may each comprise a ferromagnetic material), that may pull these components together.

The fluid disposed in the fluid holding element of the dynamic optic may be dispersed over the area of the dynamic lens 1001 (up to and including the periphery edge 1031) when the dynamic optic is deactivated. When the force from the electromagnet 1016 is applied to the portions of the peripheral edge 1031 of the fluid holding element of the dynamic optic that are disposed between the two components of the electromagnet 1016 (and/or any other portion of the electronic controlled fluid holding element that a force is applied to), the fluid from the peripheral edge 1031 may be forced into the central region of the dynamic optic 1001. The flexible element (e.g. the convex surface of the fluid holding element of the dynamic optic 1001, which may for instance comprise a membrane) may have its radius of curvature change based on the amount of fluid that is applied to a the central region of the dynamic optic 1001. In this manner, dynamic optic 1001 may provide optical add power to at least a portion of the contact lens 1000. That is, when the electromagnet 1016 closes, the front and back layers of the fluid holding element (e.g. the peripheral edges of the dynamic optic 1001) pull together and fluid is forced toward the center of the dynamic optic 1001 thus causing the convex curvature of the flexible element to bulge and increasing plus optical power.

When the dynamic optic 1001 is to be deactivated, the current or voltage may no longer be supplied to the electromagnet 1016, which may remove the magnetic field and thereby the force that was applied to the peripheral edge 1031 of the dynamic optic 1001. The fluid that had been applied toward the center of fluid holding element of the central optic region of the dynamic optic 1001 may then return to the peripheral edge 1031. That is, when the electronic magnet 1016 opens, the process is reversed.

FIG. 11 shows a side view of an exemplary embodiment of a self-contained electronics module 1100. This exemplary embodiment includes a dynamic optic that includes liquid crystal layer 1121; a diffractive element 1123; and a transparent optical base 1125. The self-contained electronics module 1100 also includes a transparent optical lid 1122; a bonding adhesive 1124; electronics 1126; and thin glass 1127. The exemplary embodiment in FIG. 11 thereby may provide dynamic optical add power by applying an electric field across the liquid crystal layer 1121. For instance, in some embodiments, the index of refraction of the liquid crystal layer 1121 may be indexed matched to the transparent optical base 1125, such that when the dynamic optic is not activated, the diffractive element 1123 does not provide any optical add power (because the surface structure is covered by the liquid crystal layer 1121). When the dynamic optic is activated (i.e. an electric field is applied to the liquid crystal layer 1121), the index of refraction of the liquid crystal layer 1121 and the transparent optical base 1125 may no longer match, and the diffractive element 1123 on the surface of the transparent base 1125 may provide optical add power. The electronics 1126 that control the dynamic optic may be included in the self-contained electronics module 1100, which may be bonded to the transparent base 1125 using the bonding adhesive 1124.

The self-contained electronics module 1100 in this exemplary embodiment is shown as being sealed in thin glass 1127. Thus, an exemplary manufacturing process may include providing the dynamic optic and each of the electronic components 1126 (for instance the components could be manufactured or obtained from a 3^{rd} party). The dynamic optic and the relevant electronics 1126 may be coupled into a functional unit (e.g. any necessary electrical connections may be made such that power and/or control signals may be provided to the dynamic lens). This functional unit may then be inserted into an electronics module comprising thin glass walls 1127 through an opening. The opening through which the dynamic optic and the electronics 1126 are inserted may then be covered by, for instance, utilizing the transparent optical lid 1122 (which may for instance have a thickness of approximately 10 microns). The transparent optical lid 1122 may be then be sealed (i.e. coupled to the thin glass walls 1127 of the electronics module 1100) using any suitable process, such as heat sealing, laser welding, ultrasonic welding, or the use of an adhesive bond. The sealed electronics module 1100 may then be inserted as a complete unit into an intraocular lens (which may be manufactured in a separate process) such as contact lens matrix. The intraocular lens may then also be sealed. Ins embodiments, the intraocular lens (e.g. a contact lens matrix) may be formed around the sealed self-contained electronics module.

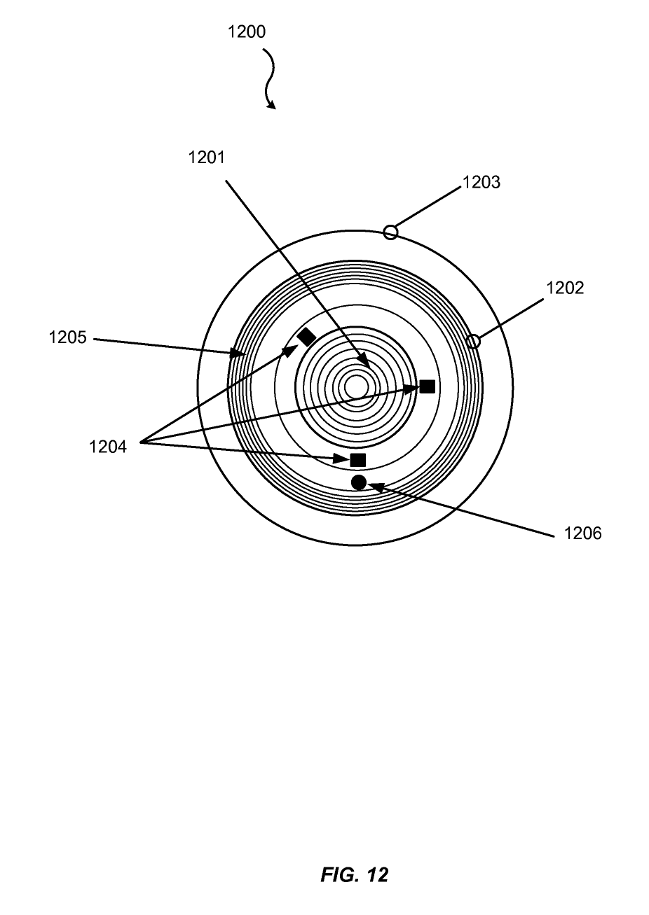

FIG. 12 shows a front view of an exemplary device in accordance with some embodiments described herein. The exemplary device 1200, having an outer perimeter 1203, is shown as comprising a contact lens that includes a dynamic optic 1201 (which is shown as comprising a diffractive electro-active element, but could for example comprise a Fresnel, pixilated, or shaped liquid crystal layer); a self-contained electronics module (the outer perimeter of which is shown as 1202); photo-detectors 1204; a capacitor 1205 (comprising induction coils); and a micro magnetic ball or member 1206. As shown in this example, the self-contained electronics module is disposed within the outer perimeter 1203 of the contact lens 1200 (i.e. it is disposed within the contact lens matrix). The dynamic optic 1201, photo-detectors 1204; capacitor 1205; and micro magnetic ball or member 1206 are each shown as disposed within the self-contained electronics module outer perimeter 1202.

In this exemplary embodiment, the power source—e.g. capacitor 1205—that provides power to the dynamic optic 1201 may be energized based on. As shown, the exemplary embodiment in FIG. 12 may utilize the motion of a metallic element (e.g. the micro-magnetic ball or member 1206) and its interaction with the induction coils of the capacitor 1205 to generate electrical charge for the device 1200. The capacitor 1205 may be in electrical communication (i.e. there may be a conductive path that enables current to flow between two or more elements) with the electronic components such as the photo-detectors 1204 that monitor the pupillary constriction upon application of an accommodative stimulus and/or the dynamic optic.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment can be combined with one or more features of any other embodiment without departing from the scope of the invention.

A recitation of “a,” “an,” or “the” is intended to mean “one or more” unless specifically indicated to the contrary.

1-110. (canceled)

111. A first device comprising:
a first lens comprising a contact lens or an intraocular lens;
wherein the first lens comprises an electronic component and a dynamic optic;
wherein the dynamic optic is configured to provide at least a first optical power and a second optical power, wherein the first optical power is different than the second optical power; and
wherein the dynamic optic comprises a fluid lens.

112. The first device of claim 111, wherein the electronic component is configured to drive the dynamic optic between the first optical power and the second optical power.

113. The first device of claim 112, wherein the electronic component comprises an electromagnet.

114. The first device of claim 112, wherein the electronic component comprises an electronic controlled bladder.

115. The first device of claim 111, further comprising:
a self-contained electronics module, wherein the self-contained electronics module contains the dynamic optic and the electronic component.

116. The first device of claim 111,
wherein the dynamic optic comprises a fluid and a fluid holding element;
wherein the fluid is disposed within the fluid holding element;
wherein the fluid holding element comprises a peripheral edge; and
wherein the shape of the flexible element is based at least in part on the amount of force applied to at least a portion of the peripheral edge of the fluid holding element.

117. The first device of claim 116, further comprising an electromagnet;
wherein the amount of force applied to the peripheral edge of the fluid holding element is based at least in part on the amount of current or voltage supplied to the electromagnet.

118. The first device of claim 117, wherein the electromagnet is disposed around at least a portion of the peripheral edge of the fluid holding element.

119. The first device of claim 117, wherein the electromagnet comprises magnetic material deposited as a layer on the fluid holding element.

120. The first device of claim 119,
wherein the material of the electromagnet comprises a ferromagnet; and
wherein the layer has a thickness that is between approximately 1 and 5 microns.

121. The first device of claim 111,
wherein the dynamic optic further comprises:
a fluid;
a fluid cavity; and
an electromagnet;
wherein the amount of fluid that is disposed within the fluid cavity is based at least in part on the amount of current or voltage supplied to the electromagnet;
wherein the optical add power of the dynamic optic is increased when fluid is applied to the fluid cavity; and
wherein the optical add power of the dynamic optic is decreased when fluid is removed from the fluid cavity.

122. The first device of claim 115, wherein the self-contained electronics module has a thickness that is between approximately 65 and 90 microns thick.

123. A first device comprising:
a self-contained electronics module;
wherein the self contained electronics module has a thickness that is less than approximately 125 microns; and
wherein the self-contained electronics module comprises:
a dynamic optic that is configured to provide at least a first optical power and a second optical power, wherein the first optical power is different than the second optical power.

124. The first device of claim 123, wherein the electronics module has a thickness that is less than approximately 60 microns.

125. The first device of claim 123, wherein the dynamic optic comprises a fluid lens.

126. The first device of claim 123, wherein the electronics module comprises micro nanotubes.

127. The first device of claim 123, wherein the electronics module comprises an electromagnet.

128. The first device of claim 123, wherein the first device comprises a capacitor.

129. A first method comprising:
providing a dynamic optic, wherein the dynamic optic comprises a fluid lens;
providing an electronic component; and
disposing the dynamic optic and the electronic component into a first lens, wherein the first lens is anyone of: a contact lens or an intraocular lens.

130. The first method of claim 129, further comprising the steps of:
disposing the dynamic optic into an electronics module; and
sealing the electronics module so as to form a self-contained electronics module.

131. The first method of claim 130, wherein the step of disposing the dynamic optic into the first lens comprises disposing the self-contained electronics module into the intraocular lens or the contact lens.

132. The first method of claim 130, wherein the self-contained electronics module contains an electromagnet.

133. A first method comprising:
providing an electronics module, wherein:
the electronics module contains an electronic component and a dynamic optic; and
the electronics module has a thickness that is less than approximately 125 microns;
sealing the electronics module so as to form a self-contained electronics module.

134. The first method of claim 133, wherein the first method further includes the step of disposing the dynamic optic into a first lens, wherein the first lens comprises anyone of: a contact lens or an intraocular lens.
